(19) United States
(12) Patent Application Publication
(10) Pub. No.: US 2025/0258535 A1
(43) Pub. Date: Aug. 14, 2025

(54) SIGNAL MEDIATED LINK STATE POWER MANAGEMENT (LPM)

(71) Applicant: QUALCOMM Incorporated, San Diego, CA (US)

(72) Inventors: Prakhar Srivastava, Lucknow (IN); Santhosh Reddy Akavaram, Hyderabad (IN); Chintalapati Bharath Sai Varma, Hyderabad (IN); Rajendra Varma Pusapati, Hyderabad (IN); Ravi Kumar Sepuri, Hyderabad (IN)

(21) Appl. No.: 18/439,633

(22) Filed: Feb. 12, 2024

(51) Int. Cl. G06F 1/3293

(52) U.S. Cl. CPC G06F 1/3293

(57) ABSTRACT

This disclosure provides systems, methods, and devices for interconnecting components of an electronic device through a bus interface that supports signal mediated link state power management (LPM). In a first aspect, a method of signal mediated LPM includes entering, based on expiration of a preconfigured time period, a first link state with respect to a bus that couples the first component to a second component of the electronic device. Additionally, the method includes receiving one or more signals via a first interrupt line of the bus, via a second interrupt line of the bus, or a combination thereof. Further, the method includes transitioning from the first link state to a second link state with respect to the bus based on the one or more signals, the second link state having lower operating power than the first link state. Other aspects and features are also claimed and described.

### TECHNICAL FIELD

Aspects of the present disclosure relate generally to computer information systems, and more particularly, to communications systems for coupling components of computer information systems. Some features may enable and provide improved bus or interconnect capabilities to facilitate signal mediated link state power management (LPM).

### INTRODUCTION

Computer information systems may include many components including expansion circuit boards (such as mother and daughter cards), integrated circuit (IC) devices, and/or System-on-Chip (SoC) devices. The components may include processing circuits, user interface components, storage components, and/or other peripheral components. Communication between components may be implemented using a bus. The bus may be operated in compliance with standards-defined specifications and protocols. One example of such a specification-defined interface to a bus is the Peripheral Component Interconnect Express (PCIe) interface. PCIe provides a shared parallel bus architecture that supports interconnection of two devices using links that include one or more serial, full-duplex lanes.

The value and use of information by individuals continues to increase, as do computational requirements. Computational processes performed by computer information systems rely on busses to transmit interface components, so that each component may perform an assigned task. The tasks may include processing, compiling, storing, and/or communicating information for business, personal, or other purposes thereby allowing users to take advantage of the value of the information. Technology and information handling needs and requirements vary between different users and different applications and different computer information systems, such that there may be differences in how the information is handled, processed, stored, or communicated. The variations in information handling allow for computer information systems to be general or configured for a specific user or specific use, such as financial transaction processing, airline reservations, enterprise data storage, or global communications. The buses that interconnect components of computer information systems components are generally capable of supporting the use of the information to increase the value of the information but also provide specialized features to support certain operations or increase performance when performing certain tasks or kinds of information.

PCIe includes a plurality of link power modes or states. In an active link state, referred to as an L0 state, transaction layer packet (TLP) and data link layer packet (DLLP) transmission are enabled on one or more links that interconnect at least a first component of a device to at least a second component of the device. However, when the device enters into a lower power state, power management (PM) module (software, hardware, firmware, or a combination of them) associated with the device directs a downstream component of the device, such as the second component of the device, to enter into a D3ₕₒₜ state.

In response to the PM module causing the downstream component to transition to the D3ₕₒₜ state, the downstream component initiates transition of the link to a lower power state, referred to as an L1 state or an intermediary low power link state. While in the L1 state, TLP and DLLP transmission on the link are disabled thereby causing data lanes of the bus to be in an inactive state (e.g., a quiescent state); however, main power supplies remain active. Further, while in the L1 state, internal phase locked loops (PLLs) associated with the first component, the second component, or both may be inactivated.

Additionally, the PM module causes a root complex of the device to broadcast a power management event (PME) turn off message, referred to as PME_Turn_Off, to prepare for removal of a main power source. The PME turn off message causes the link to transition back to the active link state (e.g., the L0 state) so that the PME turn off message may be broadcast on the data lanes and to enable the downstream component to respond to the PME turn off message with an acknowledgment message, referred to as the PME_to_Ack message.

After the downstream component sends the acknowledgment message, the downstream component initiates an L2/L3 ready transition protocol to prepare for entry to an intermediate deep power saving link state, referred to as an L2/L3 state. In the L2/L3 state, the first component, the second component, or both are ready for main power removal and loss of clocks. In response to main power being removed, the link transitions to a first deep power saving link state, referred to as an L2 state, if auxiliary power is provided. Otherwise, the link transitions to a second deep power saving link state, referred to as an L3 state.

In response to completing preparations for loss of main power and clocks, the downstream component initiates L2/L3 entry by sending an L2/L3 entry message, referred to as the PM_Enter_L23 DLLP message, to an upstream component, such as to the first component. In response to receipt, by the downstream component, of an acknowledgement message in response to the L2/L3 entry message or in response to loss of main power, the link enters into an L2 or L3 state, depending on the availability of auxiliary power.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Certain aspects of the disclosure relate to systems, apparatus, methods and techniques that facilitate transition of a link to a lower power link state from a higher power link state. In some aspects, a first component of an electronic device receives one or more signals via a first interrupt line of a bus, via a second interrupt line of the bus, or a combination thereof while data lanes of the bus are in an inactive state (e.g., a quiescent state). The first component transitions from a first link state to a second link state with respect to the bus based on the one or more signals received via the first interrupt line, the second interrupt line, or both. The second link state has a lower operating power than the first link state.

In some implementations, the first component may receive a first signal via the first interrupt line and may receive a second signal via the second interrupt line while data lanes of the bus are in an inactive state. The first component may decode the first signal and the second signal to generate a plurality of sideband interrupt signals. A value of at least one sideband interrupt signal of the plurality of sideband interrupt signals may initiate the transition from the first link state to the second link state.

In some implementations, the first component may receive a first signal via the first interrupt line and may receive a second signal via the second interrupt line while data lanes of the bus are in an inactive state. The first signal may include a data signal and the second signal may include a clock signal. The first component may process the data signal based on the clock signal. The processed data signal may initiate the transition from the first link state to the second link state.

In some implementations, the one or more signals include a modulated data signal. The first component may demodulate the modulated data signal. The demodulated data signal may initiate the transition from the first link state to the second link state.

In some implementations, the second component of the device may receive a first set of one or more signals via a first interrupt line of the bus, via a second interrupt line of the bus, or a combination thereof. The second component may transmit a second set of one or more signals via the first interrupt line of the bus, via the second interrupt line of the bus, or a combination thereof in response to receipt of the first set of one or more signals. The first set of one or more signals are received and the second set of one or more signals are transmitted while data lanes of the bus are in an inactive state. Additionally, transmission of the second set of one or more signals initiates, in the second component, a transition from a first link state to a second link state with respect to the bus, the second link state having lower operating power than the first link state.

The systems, apparatus, methods and techniques may be incorporated into logic circuitry as a bus interface and built in an integrated circuit (IC) on a semiconductor die. The IC may be integrated into other components, such as a central processing unit (CPU) (including an applications processor), a graphics processing unit (GPU), a controller of a storage device, a communications processor (e.g., a wireless modem for 3G, 4G LTE, 5G NR, Wi-Fi, Bluetooth, a wireline transceiver for Ethernet).

The methods and techniques may also or alternatively be incorporated into instructions for storage in memory, such as random access memory (RAM) or read-only memory (ROM), as firmware or software. The instructions may be executed by the logic circuitry to cause a component executing the instructions to communicate over a bus through the bus interface.

An apparatus in accordance with at least one embodiment includes a bus interface configured to support communications between a first component coupled to a bus and a second component coupled to the bus. The bus interface may include logic configured to perform operations for formatting information and generating signals for transmission on the bus, perform operations for processing signals received from the bus and extracting information from the signals. The bus interface may also include logic configured to perform operations to facilitating connections from the first component to the second component over the bus, such as by performing link training, link negotiation, link monitoring, and/or link adaptation.

In one aspect of the disclosure, a method is performed by a first component of an electronic device. The method includes entering, based on expiration of a preconfigured time period, a first link state with respect to a bus that couples the first component to a second component of the electronic device. Additionally, the method includes receiving one or more signals via a first interrupt line of the bus, via a second interrupt line of the bus, or a combination thereof. Further, the method includes transitioning from the first link state to a second link state with respect to the bus based on the one or more signals. The second link state has a lower operating power than the first link state.

In an additional aspect of the disclosure, a device includes a controller. The controller is configured to initiate entry, based on expiration of a preconfigured time period, to a first link state with respect to a bus that couples a first component of the device to a second component of the device. Additionally, the controller is configured to receive one or more signals via a first interrupt line of the bus, via a second interrupt line of the bus, or a combination thereof. Further, the controller is configured to initiate transition from the first link state to a second link state with respect to the bus based on the one or more signals. The second link state has a lower operating power than the first link state.

In an additional aspect of the disclosure, a non-transitory computer-readable storage medium stores instructions that, when executed by one or more processors, cause the one or more processors to perform operations. The operations include entering, based on expiration of a preconfigured time period, a first link state with respect to a bus that couples a first component to a second component of an electronic device. Additionally, the operations include receiving one or more signals via a first interrupt line of the bus, via a second interrupt line of the bus, or a combination thereof. Further, the operations include transitioning from the first link state to a second link state with respect to the bus based on the one or more signals. The second link state has a lower operating power than the first link state.

In an additional aspect of the disclosure, a device includes means for performing one or more operations of the methods, operations, and/or techniques described herein. For example, the device includes means for entering, based on expiration of a preconfigured time period, a first link state with respect to a bus that couples a first component of the device to a second component of the device. Additionally, the device includes means for receiving one or more signals via a first interrupt line of the bus, via a second interrupt line of the bus, or a combination thereof. Further, the device includes means for transitioning from the first link state to a second link state with respect to the bus based on the one or more signals. The second link state has a lower operating power than the first link state.

In an additional aspect of the disclosure, a method is performed by a first component of an electronic device. The method includes receiving a first set of one or more signals via a first interrupt line of a bus, via a second interrupt line of the bus, or a combination thereof. Additionally, the method includes transmitting a second set of one or more signals via the first interrupt line of the bus, via the second interrupt line of the bus, or a combination thereof in response to receipt of the first set of one or more signals. The first set of one or more signals are received and the second set of one or more signals are transmitted while data lanes of the bus are in an inactive state. Additionally, transmission of the second set of one or more signals initiates, in a second component, a transition from a first link state to a second link state with respect to the bus. The second link state has a lower operating power than the first link state.

In an additional aspect of the disclosure, a device includes a controller. The controller is configured to receive a first set of one or more signals via a first interrupt line of a bus, via a second interrupt line of the bus, or a combination thereof. Additionally, the controller is configured to initiate transmission of a second set of one or more signals via the first interrupt line of the bus, via the second interrupt line of the bus, or a combination thereof in response to receipt of the first set of one or more signals. The first set of one or more signals are received and the second set of one or more signals are transmitted while data lanes of the bus are in an inactive state. Additionally, transmission of the second set of one or more signals initiates, in a second component, a transition from a first link state to a second link state with respect to the bus. The second link state has a lower operating power than the first link state.

In an additional aspect of the disclosure, a non-transitory computer-readable storage medium stores instructions that, when executed by one or more processors, cause the one or more processors to perform operations. The operations include receiving a first set of one or more signals via a first interrupt line of a bus, via a second interrupt line of the bus, or a combination thereof. Additionally, the operations include initiating transmission of a second set of one or more signals via the first interrupt line of the bus, via the second interrupt line of the bus, or a combination thereof in response to receipt of the first set of one or more signals. The first set of one or more signals are received and the second set of one or more signals are transmitted while data lanes of the bus are in an inactive state. Additionally, transmission of the second set of one or more signals initiates, in a second component, a transition from a first link state to a second link state with respect to the bus. The second link state has a lower operating power than the first link state.

In an additional aspect of the disclosure, a device includes means for performing one or more operations of the methods, operations, and/or techniques described herein. For example, the device includes means for receiving a first set of one or more signals via a first interrupt line of the bus, via a second interrupt line of the bus, or a combination thereof. Additionally, the device includes means for transmitting a second set of one or more signals via the first interrupt line of the bus, via the second interrupt line of the bus, or a combination thereof in response to receipt of the first set of one or more signals. The first set of one or more signals are received and the second set of one or more signals are transmitted while data lanes of the bus are in an inactive state. Additionally, transmission of the second set of one or more signals initiates, in the second component, a transition from a first link state to a second link state with respect to the bus. The second link state has a lower operating power than the first link state.

In some aspects, the bus interface may be implemented in battery-operated devices, including certain mobile communication devices. Mobile devices may be designed to meet increasingly tighter power consumption budgets in order to increase operating time while operating from a battery or other limited power supply. Aspects of this disclosure may be used in mobile communication devices to improve power efficiency or reduce power consumption when transmitting information between components coupled to a bus. As applications generate continuously-increasing demand for improved communication capabilities including higher data rates, lower data transmission latencies and improved battery conservation, there exists an ongoing need for improved power management that may be addressed by certain aspects of this disclosure.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a bus interface to perform the steps of the method. In some embodiments, the bus interface may be integrated with a processor that is part of a mobile device including a first network adaptor coupled to the processor through the bus interface with the first network adaptor configured to transmit data (e.g., images or videos in a previously-recorded file or as streaming data) over a first network connection of a plurality of network connections. The processor may be coupled to the first network adaptor and a memory for storing data through a common bus interface or multiple bus interfaces to support the processing and communications operations performed by the processor. The network adaptor may support communication over a wireless communications network such as a 5G NR communication network. The processor may cause the transmission of data by retrieving the data stored in memory over a bus interface, package the data for transmission on a selected network, and transmit the packaged data through the bus interface to the first network adaptor for transmission on the wireless communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.).

While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations.

In some configurations, devices incorporating described aspects and features may also include additional components and features for implementation and practice of claimed and described aspects. For example, transmission and reception of wireless signals may includes a number of components for analog and digital purposes (e.g., hardware components including antenna, radio frequency (RF)-chains, power amplifiers, modulators, buffer, processor(s), interleaver, adders/summers, etc.). Innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a state diagram associated with a transition from an active link state to a LPM link state according to a conventional approach.

FIG. 2 illustrates an example of an apparatus that may be adapted according to certain aspects disclosed herein.

FIG. 3 illustrates an example of an architecture for a PCIe interface.

FIG. 4 illustrates an example of an electronic device configured to facilitate a transition from a first link state to a second link state according to one or more aspects.

FIG. 5 illustrates an example state diagram associated with facilitating a transition from a first link state to a second link state according to one or more aspects.

FIG. 6 illustrates an example of an electronic device configured to facilitate a transition from a first link state to a second link state according to one or more aspects.

FIG. 7 illustrates example decoding circuitry according to one or more aspects.

FIG. 8 is a timing diagram associated with a first sideband interrupt signal according to one or more aspects.

FIG. 9 is a timing diagram associated with a second sideband interrupt signal according to one or more aspects.

FIG. 10A is a timing diagram associated with a third sideband interrupt signal according to one or more aspects.

FIG. 10B is a timing diagram associated with a third sideband interrupt signal according to one or more aspects.

FIG. 11A is a timing diagram associated with a fourth sideband interrupt signal according to one or more aspects.

FIG. 11B is a timing diagram associated with a fourth sideband interrupt signal according to one or more aspects.

FIG. 12 is a flow a flow chart depicting an example method to facilitate a transition from a first link state to a second link state according to one or more aspects.

FIG. 13 is a flow a flow chart depicting an example method to facilitate a transition from a first link state to a second link state according to one or more aspects.

FIG. 14 is a block diagram illustrating details of an example wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques to facilitate enhanced LPM according to one or more implementations. A first component of an electronic device enters, based on expiration of a preconfigured time period, a first link state with respect to a bus that couples the first component to a second component of the electronic device. For example, the first component may enter into an intermediary low power link state (e.g., an L1 state) from an active link state (e.g., an L0 state) based on expiration of a preconfigured time period such as may be indicated by a clock. Additionally, the first component of the electronic device receives one or more signals via a first interrupt line of the bus, via a second interrupt line of the bus, or a combination thereof. For example, the first component may receive a first signal via the first interrupt line, and the first component may receive a second signal via the second interrupt line. Further, the first component transitions from a first link state to a second link state with respect to the bus based on the one or more signals. To illustrate, in some implementations, the first component may decode the first signal and the second signal to generate a first sideband interrupt signal. A value of the first sideband interrupt signal may cause the transition from the first link state to the second link state. The second link state has a lower operating power than the first link state. For example, the first link state may include or correspond to the intermediary low power link state (e.g., the L1 state) and the second link state may correspond to a first deep power saving link state (e.g., an L2 state) or to a second deep power saving link state (e.g., an L3 state).

In some implementations, the one or more signals include or correspond to a modulated data signal. The first component may demodulate the modulated data signal and may transition from the first link state (e.g., the L1 state) to the second link state (e.g., the L2 state or the L3 state) based on the demodulated data signal. The demodulated data signal may include or correspond to an acknowledgement message received from the second component.

In some implementations, the first signal includes or corresponds to a data signal. The second signal includes or corresponds to a clock signal. The first component may process the data signal based on the clock signal. Additionally, the first component may transition from the first link state to the second link state based on the data signal. The data signal may indicate an acknowledgement from the second component, such as in response to a request, by the first component, to transition to the low power link state.

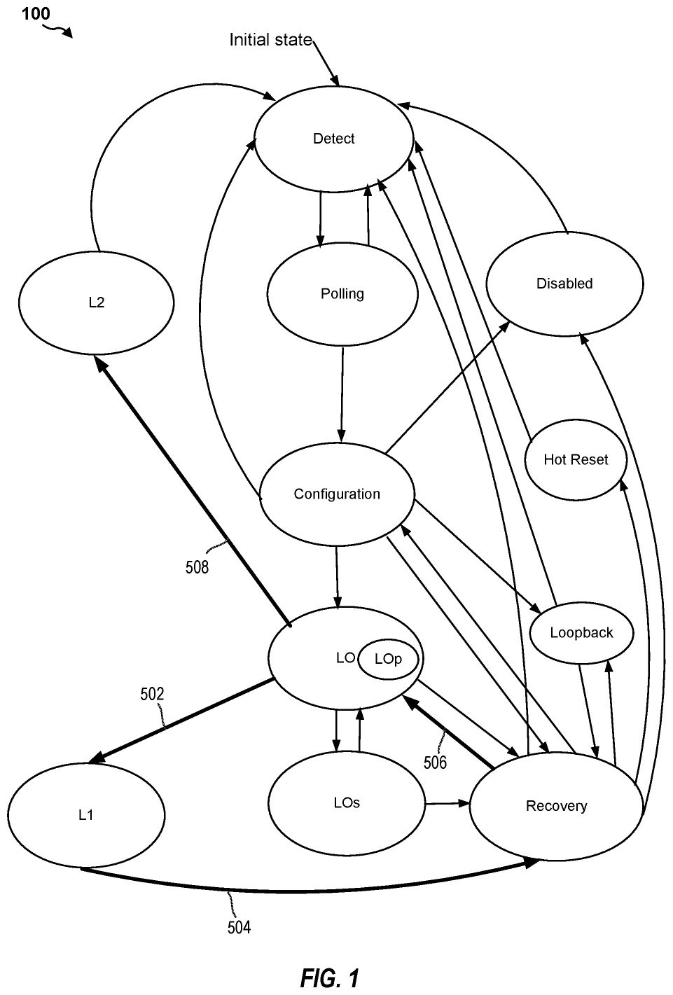

Particular implementations of the subject matter described in this disclosure may be implemented to realize one or more of the following potential advantages or benefits. In some aspects, the present disclosure provides enhanced LPM. Referring to FIG. 1, which illustrates a state diagram associated with a transition from an active link state to a low power link state according to a conventional approach, to transition from the active link state (e.g., the L0 state) to a first deep power saving link state (e.g., the L2 state) or a second deep power saving link state (e.g., the L3 state), a component of an electronic device first transitions to the intermediary low power link state (e.g., the L1 state) at 502.

However, in the intermediary low power link state (L1), any PLLs, clocks, or both associated with the first component are disabled, thereby resulting in loss of a bit lock and a symbol lock. Accordingly, from the intermediary low power link state (L1), the link transitions to a recovery state at 504, in which the bit lock and symbol lock are recovered. Subsequently, from the recovery state, the link transitions, at 506, to the active link state (e.g., the L0 state). In the active link state, a power management event (PME) handshake negotiation process occurs between a route complex of the device (e.g., a first component of the device) and an endpoint of the device (e.g., a second component of the device). In response to a successful handshake process, the link transitions, at 508, from the active link state to the first deep power saving link state (e.g., L2) if auxiliary power is available or to the second deep power link state (e.g., L3) if auxiliary power is unavailable. In both the first deep power saving link state and the second deep power saving link state, bit locks and symbol locks are again lost.

Additionally, in devices that support a low resume latency standby link state (e.g., L0s), to retrieve the link from the low resume latency standby link state to the active power link state (e.g., in transitioning from L0s to L0), fast training sequences (FTS) are exchanged between the first component and the second component. The first component and the second component typically negotiate the quantity of FTSs exchanged between them, and this value is indicated in symbol three of a sixteen symbol training sequence (TS)1 or TS2 ordered set.

Therefore, in a conventional PCIe protocol, to transition from an active link state (e.g., the L0 state) to a first deep power saving link state (e.g., the L2 state) or to a second deep power saving link state (e.g., the L3 state), the link must first return to the active link state from the recovery state. Returning to the active link state prior to transitioning to the first deep power saving link state or to the second deep power saving link state wastes power and increases overall system latency. In particular, for generation 1 link speed and for a link width of 1 (e.g., gen 1×1), a power expenditure associated with entering the active link state could be 48.85 mW. For generation 1 link speed and for a link width of 2 (e.g., gen 1×2), a power expenditure associated with entering the active link state could be 76.55 mW. Further, during typical operation, a component of an electronic device may transition multiple times from an active link state to a first deep power saving link state or to the second deep power saving link state. Therefore, significant quantities of power and time are wasted in the conventional PCIe protocol.

In contrast to the conventional PCIe protocol, the disclosure facilitates transition from the active link state (e.g., L0) to the first deep power saving link state (e.g., L2) or to the second deep power saving link state (e.g., L3) via an intermediary low power link state (e.g., L1) based on one or more signals received via a first interrupt line of a bus that couples the first component to a second component of the electronic device, a second interrupt line of the bus, or a combination thereof. Accordingly, by transitioning from a first link state, such as the intermediary low power link state, to a second link state, such as a first deep power saving link state or the second deep power saving link state, entry into a recovery state and re-entry into the active link state are avoided. Accordingly, by avoiding entry into the recovery state and re-entry into the active link state, power and time are conserved. Over multiple state transitions from an active link state to a first deep power saving link state or a second deep power saving link state via an intermediary low power link state, significant power and time savings may accrue.

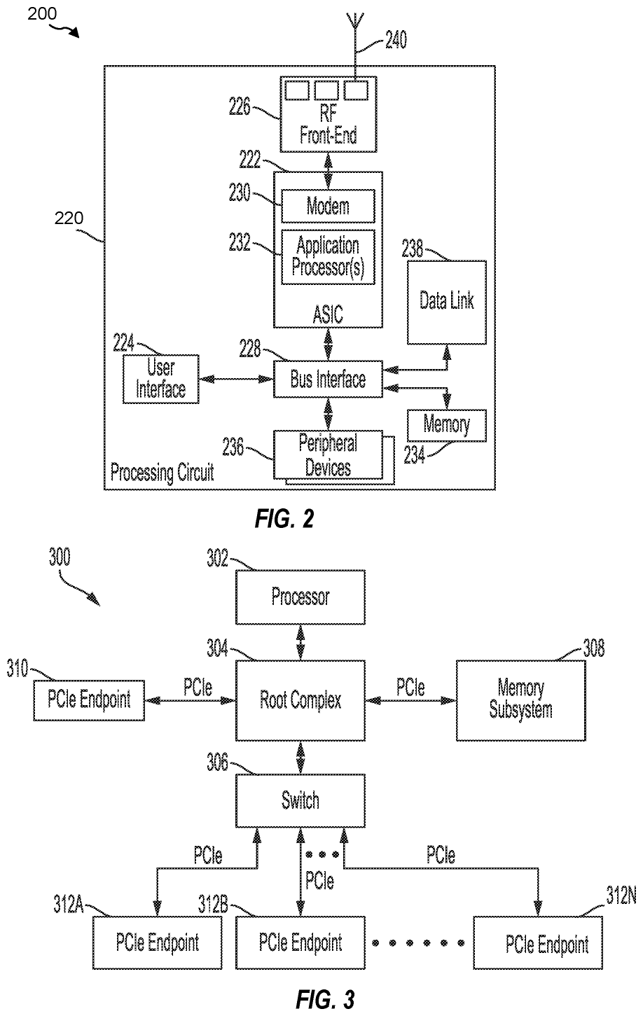

According to certain aspects, a bus interface, such as a PCIe bus interface, may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, or any other similar functioning device. FIG. 2 depicts an example of such an apparatus, denoted apparatus 200. Apparatus 200 may include processing circuit 220 having multiple devices or circuits 222, 224, 226, 228, 236, and/or 238. Processing circuit 220 may be implemented in an application-specific IC (ASIC) or system on chip (SoC) that may include multiple devices or circuits 222, 224, 226, 228, 236, and/or 238 as different components that may communicate with each other through busses. In one example, apparatus 200 may be a communication device and processing circuit 220 may include modem 230 that interfaces with radio frequency (RF) RF front-end circuit 226 that enables apparatus 200 to communicate through one or more antennas 240 with a radio access network, a core access network, the Internet and/or another network.

Processing circuit 220 includes application-specific integrated circuit (ASIC) device 222 that has one or more application processors 232 (e.g., a heterogenous mix of processors of different configurations, such as performance cores and efficiency cores), one or more modems 230 (e.g., baseband modems), and/or other logic circuits or functions. Processing circuit 220 may be controlled by a basic input/output system (BIOS), firmware, and/or an operating system and may provide an application programming interface (API) layer that enables one or more processors 232 to execute software modules residing in memory device 234. The software modules may include instructions and data stored in a processor readable storage such as memory device 234.

ASIC device 222 may access an internal memory, memory device 234, and/or storage devices included in peripheral devices 236 or storage devices outside processing circuit 220. Memory 234 may include read-only memory (ROM) or random-access memory (RAM), electrically erasable programmable ROM (EEPROM), flash cards, or any memory device that can be used in processing systems and computing platforms. Processing circuit 220 may include, or have access to, a local database or other parameter storage that maintains operational parameters and other information used to configure and operate apparatus 200 and/or processing circuit 220. The local database may be implemented using registers, a database module, flash memory, magnetic media, EEPROM, optical media, tape, soft or hard disk, or the like. Processing circuit 220 may also be operably coupled to external devices such as antennas 240, a display, user interface 224 (e.g., a button, an integrated or external keypad, and/or a touch screen).

Processing circuit 220 may communicate through bus interface circuit 228, which may include a combination of circuits, counters, timers, control logic and other configurable circuits or modules. In one example, bus interface circuit 228 may be configured to operate in accordance with PCIe specifications and protocols. Processing circuit 220 may include or control a power management function that configures and manages bus interface 228, user interface 224, RF front-end circuit 226, and the operation of one or more application processors 232 resident in ASIC device 222. In certain modes of operation, bus interface circuit 228 may be configured to transition between power states based on activity of bus interface 228.

Bus interface 228 operates using one or more links. In an embodiment of a PCIe interface, bus interface 228 may operate using high-speed serial links. Bus interface 228 may be characterized as having a point-to-point topology, with separate serial links connecting each device to a host, or root complex. FIG. 3 is a block diagram illustrating an example of an architecture for PCIe interface 300.

In PCIe interface 300, root complex 304 couples processor 302 to memory devices (e.g., memory subsystem 308) and PCIe switch circuit 306. In some configurations, switch circuit 306 includes cascaded switch devices. One or more PCIe endpoint devices 310 may be coupled directly to root complex 304, while other PCIe endpoint devices 312A, 312B, . . . , 312N may be coupled to root complex 304 through PCIe switch circuit 306. Root complex 304 may be coupled to processor 302 using a proprietary local bus interface or a standards-defined local bus interface. Root complex 304 may control operations of PCIe interface 300 and may generate transaction requests for processor 302. In some examples, root complex 304 is implemented in the same IC device that includes processor 302. Root complex 304 may support multiple PCIe ports.

Root complex 304 may control communication between processor 302, memory subsystem 308 and/or other PCIe endpoint devices 310, 312A, 312B, . . . , 312N. Endpoint device 310, 312A, 312B, . . . , 312N may be defined as a device other than root complex 304 that is capable of requesting or initiating a PCIe transaction or responding to a PCIe transaction. PCIe interface 300 may support full-duplex communication between any two endpoints, with no inherent limitation on concurrent access across multiple endpoints.

Information to be communicated using PCIe interface 300 is encapsulated in packets in accordance with PCIe bus protocols. Devices coupled to a PCIe bus may communicate using one or more PCIe lanes. A PCIe lane may be defined as a point-to-point communication channel between two PCIe ports. A PCIe lane may provide full-duplex communication and may include two differentially encoded pairs of signaling wires or signal traces, with one pair of wires being used for transmitting data and the other pair of wires being used for receiving data. Packets may carry information in eight-bit bytes. In a multi-lane PCIe link, packet data may be striped across multiple lanes. The number of lanes in the multi-lane link may be negotiated during device initialization.

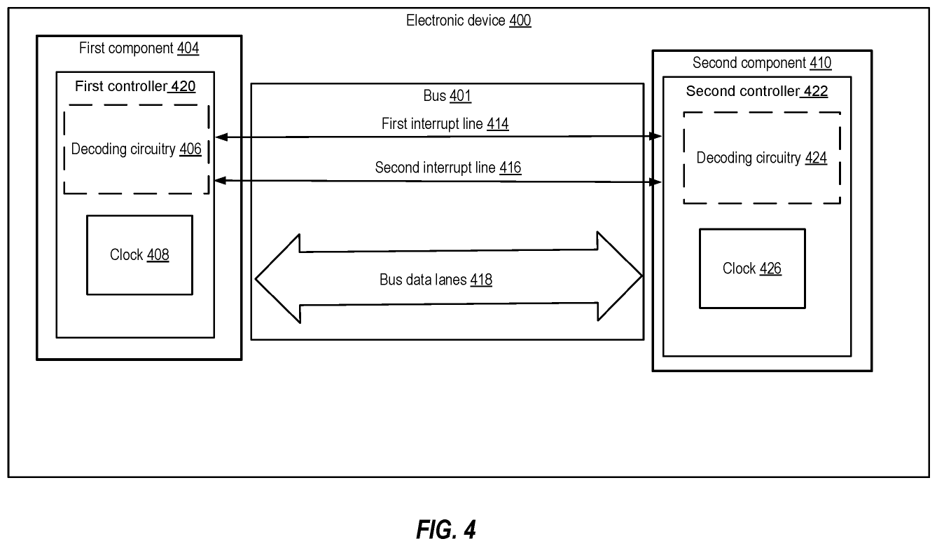

FIG. 4 illustrates an example of an electronic device configured to facilitate a transition from a first link state to a second link state according to one or more aspects. Electronic device 400 includes first component 404 and second component 410. Additionally, electronic device 400 includes bus 401. Bus 401 includes interrupt lines. For instance, bus 401 includes first interrupt line 414 and second interrupt line 416. Further, bus 401 includes bus data lanes 418.

First component 404 includes first controller 420. First controller 420 may include decoding circuitry 406 and includes clock 408. Additionally, first controller 420 may include one or more processors and one or more memories coupled to the one or more processors (not depicted). Second component 410 includes second controller 422. Second controller 422 may include decoding circuitry 424 and includes clock 426. Additionally, second controller 422 may include one or more processors and one or more memories coupled to the one or more processors (not depicted). In some implementations, decoding circuitry 406, 424 includes or corresponds to a 2×4 decoder. Additionally, in some implementations, clock 408, 426 includes or corresponds to a PLL, oscillator, or the like.

During a cycle of operation, first component 402 may enter, based on expiration of a preconfigured time period, a first link state with respect to bus data lanes 418 that couple first component 404 to second component 410. For example, in response to expiration of a time period set by clock 408, a link associated with bus data lanes 418 may transition from an active link state (e.g., an L0 state) to an intermediary low power link state (e.g., an L1 state).

Additionally, first component 402 may receive one or more signals via first interrupt line 414 of bus 401, via second interrupt line 416 of bus 401, or a combination thereof. First component 404 transitions from the first link state (e.g., the L1 state) to a second link state (e.g., a first deep power saving link state such as an L2 state, a second deep power saving link state such as an L3 state) with respect to bus 401 based on the one or more signals. The second link state (e.g., the L2 state, the L3 state) has lower operating power than the first link state (e.g., the L1 state).

Further, second component 410 may receive a first set of one or more signals via first interrupt line 414 of bus 401, via second interrupt line 416 of bus 401, or a combination thereof. Additionally, second component 410 may transmit a second set of one or more signals via first interrupt line 414 of bus 401, via second interrupt line 416 of bus 401, or a combination thereof in response to receipt of the first set of one or more signals. Second component 410 may receive the first set of one or more signals and may transmit the second set of one or more signals while bus data lanes 418 of bus 401 are in an inactive state (e.g., in an L1 state). Transmission of the second one or more signals initiates in first component 404 a transition from the first link state (e.g., the L1 state) to a second link state (e.g., the L2 state, the L3 state) with respect to bus 401. The second link state (e.g., the L2 state, the L3 state) has lower operating power than the first link state (e.g., the L1 state).

In some implementations, first component 404 transmits, to second component 410, a first signal via first interrupt line 414. The first signal includes a first data signal that indicates a request, by first component 404, to transition from the first link state, such as an intermediary low power link state (e.g., L1) to the second link state, such as a deep power saving link state (e.g., L2 or L3). Additionally, first component 404 may transmit a second signal via second interrupt line 416. The second signal includes a clock signal associated with the first data signal. Additionally, in some implementations, first component 404 receives a third signal via first interrupt line 414 and a fourth signal via second interrupt line 416. The third signal may include or correspond to a second data signal, and the fourth signal may include or correspond to a second clock signal. First component 404 may process the second data signal based on the second clock signal. In some implementations, transitioning, by first component 402, from the first link state to the second link state is based on the second data signal indicating an acknowledgement from second component 410 (e.g., an acknowledge to the request to transition to the second link state).

In some implementations, the one or more signals include a modulated data signal. In response to receipt of the modulated data signal, first component 404 may demodulate the modulated data signal. For example, first controller 420 may be configured to demodulate the modulated data signal. Accordingly, transitioning from the first link state, such as the intermediary low power link state (e.g., L1) to the second link state, such as a deep power saving link state (e.g., L2, L3) is based on the demodulated data signal indicating an acknowledgement from second component 410. In some implementations, prior to receiving the modulated data signal, first component 404 may transmit a third signal via first interrupt line 414. The third signal may include or correspond to a second modulated data signal that indicates a request to transition to the second link state by first component 404.

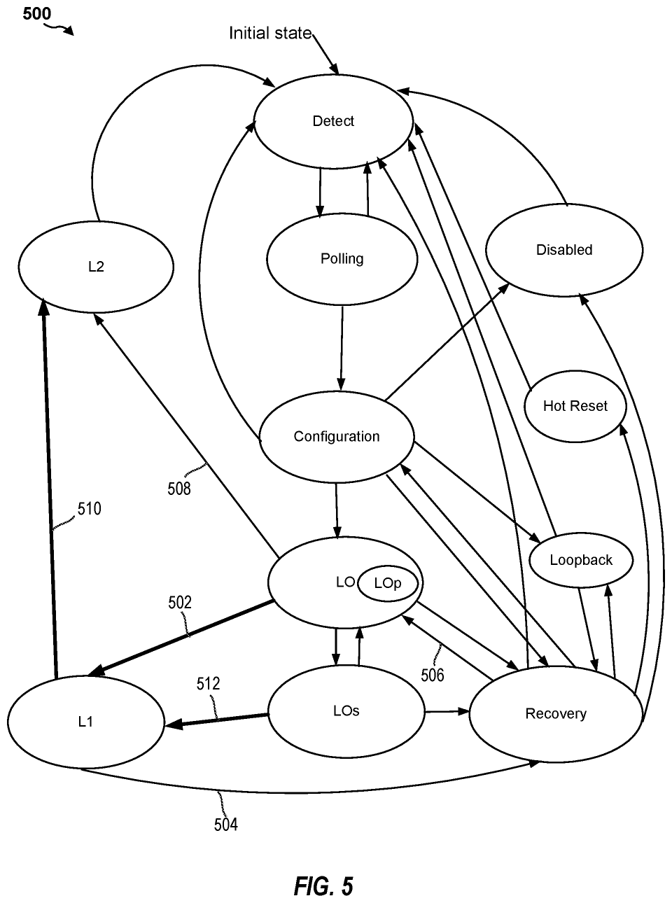

First component 404, second component 410, or both may facilitate signal mediated LPM as illustrated with reference to FIG. 5. FIG. 5 illustrates an example state diagram associated with facilitating signal mediated LPM. As shown in FIG. 5, by using signals transmitted over first interrupt line 414 and second interrupt line 416 to mediate link state transitions, a link may proceed from an active link state, such as an L0 state, via 502, to an intermediary low power link state (e.g., an L1 state). Subsequently, the link may proceed, at 510, from the intermediary low power link state (e.g., an L1 state) to a first deep power saving link state (e.g., an L2 state) or to a second deep power link saving state (e.g., an L3 state) directly from being in the intermediary low power link state (e.g., an L1 state). Additionally, if a low resume latency standby link state (e.g., L0s) is supported by the device, a link may proceed from the low resume latency standby link state (e.g., L0s), via 512, to the intermediary low power link state (e.g., an L1 state). Thereafter, at 510, the link may proceed from the intermediary low power link state (e.g., an L1 state) to the first deep power saving link state (e.g., an L2 state) or to the second deep power link saving state (e.g., an L3 state) directly from being in the intermediary low power link state (e.g., an L1 state). In contrast to the foregoing, in a conventional approach, the link transitions, at 502, from an active link state, such as an L0 state to an intermediary low power link state (e.g., an L1 state). Subsequently, at 504, the link transitions from the intermediary low power link state (e.g., an L1 state) to a recovery state. Thereafter, at 506, the link transitions from the recovery state to the active link state (e.g., L0). From the active link state (e.g., L0), the link transitions, at 508, to the first deep power saving link state (e.g., an L2 state) or to a second deep power link saving state (e.g., an L3 state). Therefore, unlike in the conventional approach, the technique described with reference to FIGS. 4 and 5 avoids entering into a recovery state and re-entering the active link state (e.g., L0) prior to transitioning to the deep power saving link states (e.g., L2, L3).

The disclosure hereof provides numerous advantages. By initiating a transition from a first link state, such as an L1 state, to a second link state, such as a first deep power saving link state or a second deep power saving link state, based on one or more signals received via interrupt lines, the state transition may expend less power and occur more rapidly than through application of conventional techniques. To illustrate, in a conventional system, to transition from a first link state, such as an L1 state, to a second link state, such as an L2 state or an L3 state, the link first returns to an active link state, such as an L0 state after passing through a recovery state, as depicted in FIG. 1. In particular, through application of conventional techniques, when the link transitions from the L0 state to the L1 state, any PLLs, clocks, or both associated with the first component are disabled, thereby resulting in loss of a bit lock and symbol lock. Accordingly, through application of conventional techniques, to transition from the L1 state to the L2 or L3 states, the link must first transition to a recovery state to recover bit lock and symbol lock. Subsequently, from the recovery state and through application of conventional techniques, the link transitions to the L0 state before the link transitions to the L2 or L3 states.

Transitioning to the recovery state and L0 state before transitioning to the L2 or L3 states unnecessarily expends power and introduces latency. For example, for a gen 1 link speed and a link width of 1 (e.g., Gen lxi), transitioning to L0 expends approximately 45.85 mW of power. Since PME negotiations occur to transition from L0 to L2 or L3, the total energy expenditure involved translates to approximately 45.85 mW (e.g., corresponding to an amount of time to conclude PME negotiations).

Further, transitioning to the recovery state and then to L0 prior to transitioning to L2 or L3 expends approximately 100 p s of time. For higher link speeds and larger link widths, these power and time expenditures scale. For instance, for gen 1 link speed and a link width of 2 (e.g., Gen 1×2), approximately 76.55 mW of power are expended to transition from L0 to L2 or L3. Since multiple link state transitions occur in any given timeframe, the foregoing power and time expenditures are, cumulatively, substantial.

Since the disclosure avoids transitioning to a recovery and L0 state prior to transitioning to L2 or L3, significant power and time savings accrue. For example, by facilitating a transition directly from the L1 state to the L2 or L3 states without first transitioning to a recovery state and the L0 state, the disclosure saves approximately 45.85 mW of power for a Gen 1×1 and at least 76.55 mW of power for Gen 1×2. These power savings scale with increasing gen speeds, link width, and quantity of transitions to the LPM link states.

Additionally, the disclosure reduces latency. By avoiding entry into the recovery and L0 states prior to transitioning to the deep power saving link states (e.g., L2, L3), time is saved. For example, approximately 100 s or more of time are saved by avoiding entry into the recovery and L0 states prior to transitioning to the deep power saving link states (e.g., L2, L3). Further, these time savings scale with increasing gen speeds, link width, and quantity of transitions to the deep power saving link states. Accordingly, the disclosure provides enhanced LPM by reducing power consumption and time usage in link state transitions.

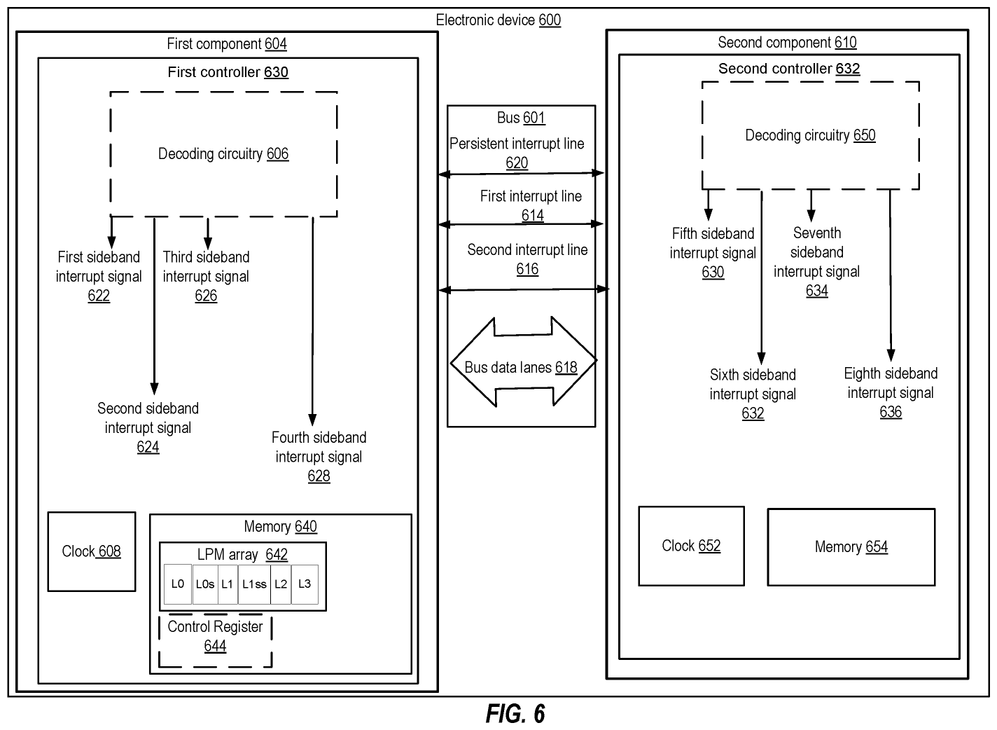

FIG. 6 illustrates an example of an electronic device configured to facilitate a transition from a first link state to a second link state according to one or more aspects. Electronic device 600 corresponds to electronic device 400. Electronic device 600 includes first component 604 and second component 610, which correspond, respectively, to first component 404 and second component 410. Further electronic device 600 includes bus 601, which corresponds to bus 401. Bus 601 includes a plurality of interrupt lines, such as persistent interrupt line 620, first interrupt line 614, and second interrupt line 616. First interrupt line 614 and second interrupt line 616 correspond, respectively, to first interrupt line 414 and second interrupt line 416. Additionally, bus 601 includes bus data lanes 618, which correspond to bus data lanes 418.

Further, first component 602 includes first controller 630. First controller 630 may include decoding circuitry 606 and includes clock 608, which correspond, respectively, to decoding circuitry 406 and clock 408. Moreover, controller 630 may include one or more processors (not depicted). Additionally, first controller 630 includes one or more memories (collectively “memory 640”), which may be coupled to the one or more processors. Memory 640 is configured to store LPM array 642. LPM array 642 may include or correspond to a data structure configured to store information corresponding to link states in decreasing order of link state power consumption. For instance, LPM array 642 may store data associated with the L0 state, L0s state, L1 state, L1ss state, L2 state, and L3 state, each representing a state associated with less power usage that the immediately preceding state. It is understood that the states depicted in LPM array 642 are provided as examples. In implementations, one or more of the foregoing states are not supported. For instance, first component 604 may not support the L0s state, the Liss state, or both.

Additionally, memory 640 may include control register 644. When a bit of control register 644 is set, then first component 604 may implement signal mediated LPM as described herein. Otherwise, device 600 may implement a conventional process. Further, when the bit of control register 644 is set, a value associated with symbol three of sixteen symbol training sequence (TS) 1 ordered sets, TS 2 ordered sets, or both may be interpreted differently than in a conventional process. For example, when symbol three, referred to as LPM_ENTR, has a value of 0×1, first component 604 may interpret the foregoing as a handshake for transition to the intermediary low power link state L1. In contrast, when LPM_ENTR has a value of 0×2, first component 604 may interpret the foregoing as a handshake transition to a deep power saving link state, such as L2 or L3. Further, when LPM_ENTR has a value of 0×0, first component 604 may interpret the foregoing as indicating no transition handshake.

In other implementations, such as those lacking control register 644, first component 604 may be configured to automatically implement signal mediated LPM as described herein. For example, in such implementations, different values associated with symbol three (e.g., LPM_ENTR) of TS 1 ordered sets, TS 2 ordered sets, or both may indicate initiation of particular handshake processes. For instance, a first value of symbol three, such as a value of 0×1, may indicate a handshake process for transition to intermediary low power link state L1. As another example, a second value of symbol three, such as a value of 0×2, may indicate a handshake process for transition to a deep power saving link state (e.g., L2 or L3). In yet another example, a third value of symbol three, such as a value of 0×0, may indicate no transition handshake process.

Second component 610 includes second controller 632, which may correspond to first controller 630. Further, second controller 632 may include decoding circuitry 650, clock 652, and one or more memories (collectively “memory 654”). While not depicted, memory 654 may also include an LPM array and a control register. Further, second controller 632 may include one or more processors (not depicted) coupled to the one or more memories.

During a cycle of operation, first component 604 may indicate, to second component 610, a request by first component 602 to enter into a first deep power saving link state (e.g., L2) or into a second deep power saving link state (e.g., L3). In particular, to indicate, to second component 610, the request, first component 604 may transmit a first signal to second component 610 via first interrupt line 614 and may transmit a second signal to second component 610 via second interrupt line 616. Decoding circuitry 650 of second component 610 may decode the first signal and the second signal to a first value of fifth sideband interrupt signal 630 (e.g., a logical low). The fifth sideband interrupt signal 630 may be referred to as Transition_LPM or T_LPM. In response to receipt of the first value of fifth sideband interrupt signal 630, second component 610 may be configured to generate an acknowledgment to the request made by first component 604. To generate the acknowledgment and in response to receipt of the first value of the fifth sideband interrupt signal 630, second component 610 may transmit, to first component 604, a third signal via first interrupt line 614 and a fourth signal via second interrupt line 616. Decoding circuitry 606 of first component 604 may receive the third signal and the fourth signal and may decode the third signal and the fourth signal to a second value of first sideband interrupt signal 622 (e.g., a logical high). First sideband interrupt signal 622 also may correspond to the T_LPM signal. Receipt, by first component 604, of the second value of first sideband interrupt signal 622 indicates, to first component 604 that second component 610 is ready for entry into the first deep power saving link state or the second deep power saving link state.

Additionally, in response to receipt, by second component 610, of the first value of fifth sideband interrupt signal 630, second component 610 may transmit, to first component 604, one or more first training sets having a first sequence. For example, the first training sets may include or correspond to TS1 ordered sets, TS2 ordered sets, or both. In some implementations, a third symbol of the TS1 ordered sets, the TS2 ordered sets, or both may have a value indicating performance of a handshake process to transition to the deep power saving link state (e.g., L2 or L3). The third symbol may be referred to as LPM_ENTR. As an example, LPM_ENTR having a value of 0×2 may indicate performance of a handshake process to transition to the deep power saving link state (e.g., L2 or L3).

In response to receipt of the one or more first training sets having the first sequence, first component 604 may transmit, to second component 610, one or more second training sets having a second sequence. For example, first component 604 may transmit, to second component 610, TS2 ordered sets in response to receipt of TS1 ordered sets from second component 610. An LPM_ENTR symbol of the transmitted TS2 ordered sets may have a value of 0×2 indicating performance of a handshake process. In some implementations, first component 604 initiates the transmission to second component 610 after receiving eight consecutive TS1 ordered sets.

Further, in response to receipt of the one or more first training sets having the first sequence, first component 604 may transition to the first deep power saving link state (e.g., L2) or to the second deep power saving link state (e.g., L3). For example, in response to lack of auxiliary power, first component 604 may transition to the second deep power saving link state (e.g., L3). Otherwise, first component 604 may transition to the first deep power saving link state (e.g., L2).

Decoding circuitry 606 of first component 604 may decode signals received via first interrupt line 614 and second interrupt line 616 to generate a plurality of sideband interrupt signals in addition to the first sideband interrupt signal 622. The plurality of sideband interrupt signals includes, in addition to first sideband interrupt signal 622, second sideband interrupt signal 624, third sideband interrupt signal 626, and fourth sideband interrupt signal 628. Each sideband interrupt signal of the plurality of sideband interrupt signals may assume a first value (e.g. a logical high, a logical low) or a second value distinct from the first value (e.g., the other of the logical high or the logical low). First component 604, second component 610, or both may perform functionality based on a value corresponding to the sideband interrupt signal.

For example, a value of first sideband interrupt signal 622 indicates whether first component 604 is to transition to a next low power link state associated with a current link state indicated by link state array 642. To illustrate, when first sideband interrupt signal 622, also referred to as Transition_LPM or T_LPM, transitions from a logical low (e.g., a value of 0) to a logical high (e.g., a value of 1), first component 604 initiates a transition to a next low power link state associated with a current link state, such as indicated by link state array 642. Hence, if the current link state of first component 604 is L0s, then transition of first sideband interrupt signal 622 from a logical low to a logical high causes first component 604 to transition to link state L1. It is understood that, in some implementations, the foregoing transition also could be effectuated by a transition of first sideband interrupt signal 622 from a logical high (e.g., a value of 1) to a logical low (e.g., a value of 0).

A value associated with second sideband interrupt signal 624 indicates whether first component 604 is to remain in the current link state. For example, a value of second sideband interrupt signal 624, which may be referred to as a no operation (NOP) signal, may cause first component 604 to remain in a current state. To illustrate, if the value of second sideband interrupt signal 624 is a logical low, then first component 604 may remain in its current state even though a transition may be indicated by a clock signal. It is understood that, in other implementations, a value of the second sideband interrupt signal 624 that is a logical low may indicate remaining in a current state.

A value of third sideband interrupt signal 626 indicates whether first component 604 requests a reference clock. For example, a value of third sideband interrupt signal 626, which may be referred to as a clock request (CLREQ) signal, may indicate that clock signal (e.g., generated by clock 608) is to be generated. To illustrate, if the value of third sideband interrupt signal 626 is a logical high, then the value may indicate a request, by first component 604, for a clock signal. It is understood that, in other implementations, a value of the third sideband interrupt signal 626 that is a logical low may indicate a request, by first component 604, for a clock signal.

A value of fourth sideband interrupt signal 628 indicates whether first component 604 is to transition to an active link state. For example, a value of fourth sideband interrupt signal 628, which may be referred to as a wake (WAKE) signal, may indicate that a link is to transition to the active link state. To illustrate, if the value of fourth sideband interrupt signal 628 is a logical low, then the value may indicate a transition to an active link state (e.g., L0). It is understood that, in other implementations, a value of fourth sideband interrupt signal 628 that is a logical high may indicate a link transition to the active link state.

Fifth sideband interrupt signal 630, sixth sideband interrupt signal 632, seventh sideband interrupt signal 634, and eighth sideband interrupt signal 636 may correspond, respectively, to first sideband interrupt signal 622 through fourth sideband interrupt signal 628. Accordingly, fifth sideband interrupt signal 630 may include or correspond to the functionality of first sideband interrupt signal 622 for second component 608 and the same concept applies to each of sixth sideband interrupt signal 632 through eighth sideband interrupt signal 636 for second component 610.

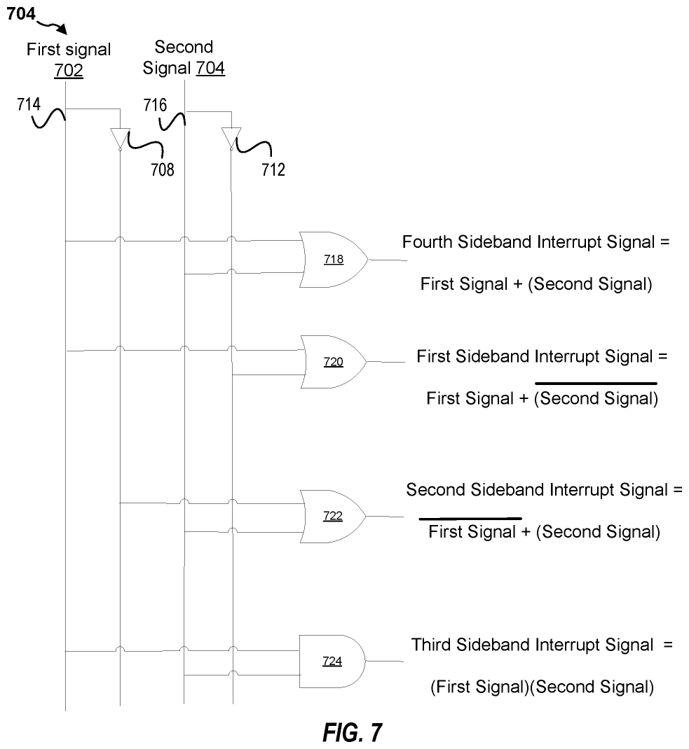

FIG. 7 illustrates example decoding circuitry according to one or more aspects. While FIG. 7 depicts decoding circuitry 704, which corresponds to decoding circuitry 406, 606 the same description applies to decoding circuitry 424, 650. Decoding circuitry includes first interrupt line 714 (corresponding to first interrupt lines 414, 614); second interrupt line 716 (corresponding to second interrupt lines 416, 616); inverters 708, 712; OR gates 718-722; and AND gate 724. First interrupt line 714 and second interrupt line 716 are configured to receive, respectively, first signal 702 and second signal 704. Based on receipt of first signal 702 and second signal 704 and, if applicable, operation of inventers 708, 712 on first signal 702 and/or second signal 704, OR gates 718-722 are configured to generate the first, second, and fourth sideband interrupt signals. Based on receipt of first signal 702 and second signal 704, AND gate 724 is configured to generate the third sideband interrupt signal.

To illustrate, OR gate 718 is configured to receive first signal 702 and second signal 704. Based on receipt of first signal 702 and second signal 704, OR gate 718 is configured to generate the fourth sideband interrupt signal. OR gate 720 receives first signal 702 and negated second signal 704. Negated second signal 704 includes or corresponds to second signal 704 that has been converted from a logical high (e.g., a high voltage value) to a logical low (e.g., a low voltage value) through operation of inverter 712 on second signal 704. Based on receipt of first signal 702 and negated second signal 704, OR gate 720 is configured to generate the first sideband interrupt signal. OR gate 722 is configured to receive negated first signal 702 and second signal 704. Negated first signal 702 includes or corresponds to first signal 702 that has been converted from a logical high (e.g., a high voltage value) to a logical low (e.g., a low voltage value) through operation of inverter 708 on first signal 702. Based on receipt of negated first signal 702 and second signal 704, OR gate 722 is configured to generate the second sideband interrupt signal. AND gate 724 is configured to receive first signal 702 and second signal 704. Based on first signal 702 and second signal 704, AND gate is configured to generate third sideband interrupt signal.

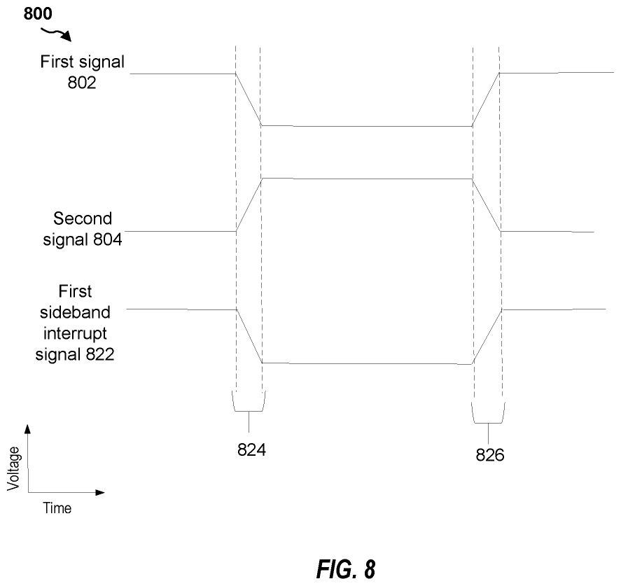

FIG. 8 is a timing diagram associated with a first sideband interrupt signal according to one or more aspects. First sideband interrupt signal 822 also may be referred to as a T_LPM signal. In particular, timing diagram 800 depicts time (x axis) against voltage (y axis). As shown in FIG. 8, during time period 824, first sideband interrupt signal 824 transitions from a logical high (e.g., a high voltage value) to a logical low (e.g., a low voltage value) when first signal 802 transitions from the logical high to the logical low and when second signal 804 transitions from the logical low to the logical high. Additionally, during time period 826, first sideband interrupt signal 822 transitions from the logical low to the logical high when first signal transitions from the logical low to the logical high and when second signal 804 transitions from the logical high to the logical low. In some implementations, the transition of first sideband interrupt signal 822 from the logical low value to the logical high value indicates a transition from a current state in a LPM array, such as LPM array 642, to a next state in the LPM array. In other implementations, the transition of first sideband interrupt signal 822 from the logical high value to the logical low value indicates the transition from the current state in the LPM array, such as LPM array 642, to the next state in the LPM array.

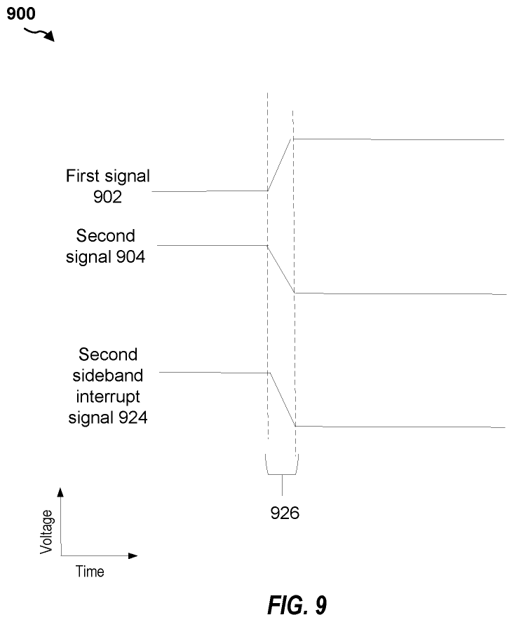

FIG. 9 is a timing diagram associated with a second sideband interrupt signal according to one or more aspects. Second sideband interrupt signal 924 also may be referred to as a NOP signal. In particular, timing diagram 900 depicts time (x axis) against voltage (y axis). As shown in FIG. 9, second sideband interrupt signal 924 transitions from a logical high to a logical low during time period 926 when first signal 902 transitions from the logical low to the logical high and when second signal 904 transitions from the logical high to the logical low. In some implementations, at a logical low, second signal 904 indicates that the link state remains in its current state (e.g., there is no link state transition). In other implementations, at a logical high, second signal 904 indicates that the link state remains in its current state (e.g., there is no link state transition).

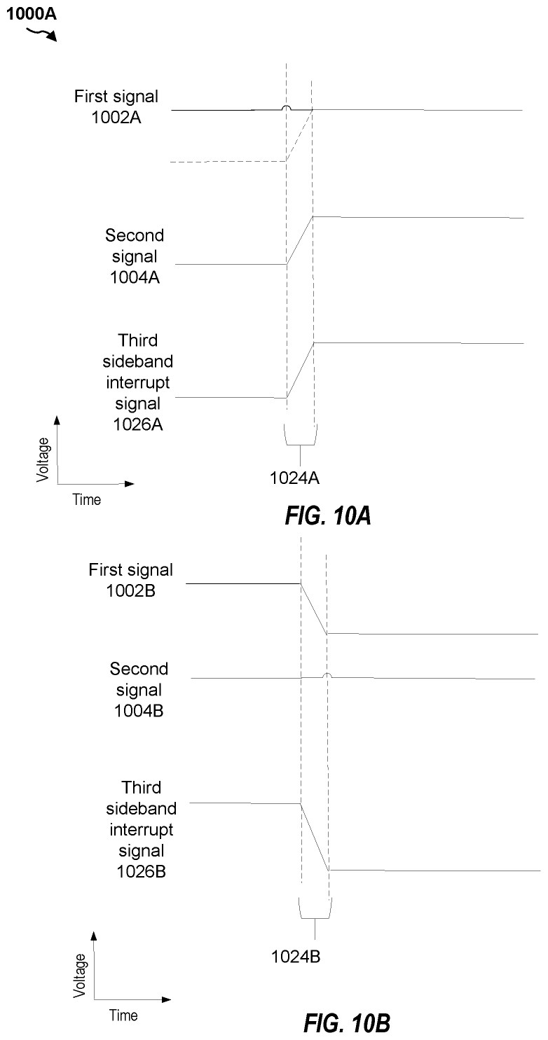

FIG. 10A is a timing diagram associated with a third sideband interrupt signal according to one or more aspects. Third sideband interrupt signal 1026A may be referred to as a CLK REQ signal. In particular, timing diagram 1000A depicts time (x axis) against voltage (y axis). As shown in FIG. 10A, third sideband interrupt signal 1026A transitions from a logical low to a logical high during time period 1024A when first signal 1002A either is at a logical high or transitions from the logical low to the logical high and when second signal 1004A transitions from the logical low to the logical high. In some implementations, at the logical high, third sideband interrupt signal 1026A indicates a request for a clock. In other implementations, at the logical low, third sideband interrupt signal 1026A indicates the request for the clock.

FIG. 10B is a timing diagram associated with a third sideband interrupt signal according to one or more aspects. Third sideband interrupt signal 1026B may be referred to as a CLK REQ signal. In particular, timing diagram 1000B depicts time (x axis) against voltage (y axis). As shown in FIG. 10B, third sideband interrupt signal 1026B transitions from a logical high to a logical low during time period 1024B when first signal 1002B transitions from a logical high to a logical low and when second signal 1004B remains at a logical high. In some implementations, at the logical low, third sideband interrupt signal 1026B deasserts a request for a clock. In other implementations, at the logical high, third sideband interrupt signal 1026B deasserts the request for the clock.

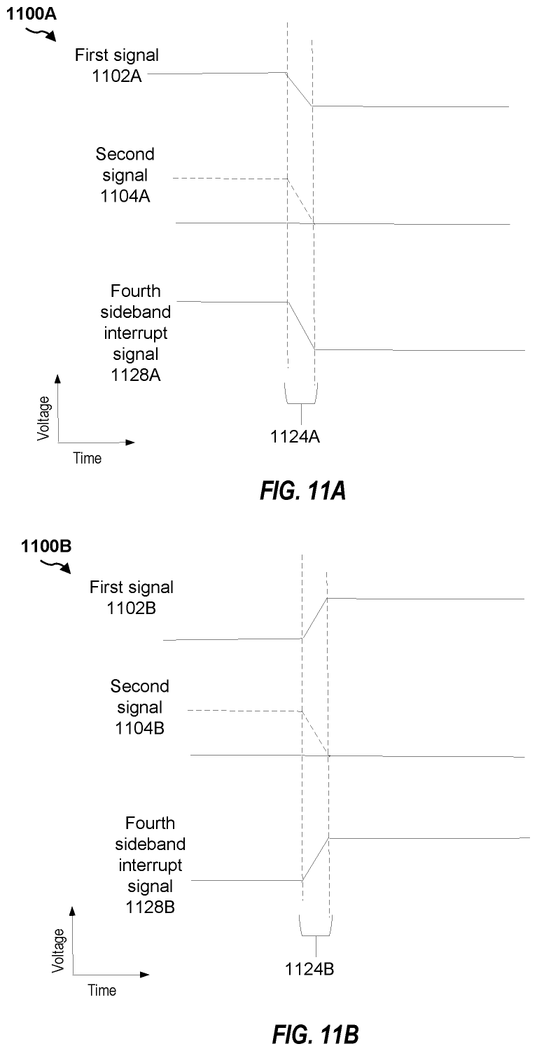

FIG. 11A is a timing diagram associated with a fourth sideband interrupt signal according to one or more aspects. Fourth sideband interrupt signal 1128A also may be referred to as a WAKE signal. In particular, timing diagram 1100A depicts time (x axis) against voltage (y axis). As shown in FIG. 11A, fourth sideband interrupt signal 1128A transitions from a logical high to a logical low during time period 1124A when first signal 1102A transitions from the logical high to the logical low and when second signal 1104A transitions from the logical high to the logical low or remains at the logical low. In some implementations, at a logical low, fourth sideband interrupt signal 1128A indicates that the link is to enter an active link state (e.g., wake is asserted). In other implementations, at a logical high, fourth sideband interrupt signal 1128A indicates that the link is to enter an active state.

FIG. 11B is a timing diagram associated with a fourth sideband interrupt signal according to one or more aspects. Fourth sideband interrupt signal 1128B also may be referred to as a WAKE signal. In particular, timing diagram 1100B depicts time (x axis) against voltage (y axis). As shown in FIG. 11B, fourth sideband interrupt signal 1128B transitions from a logical low to a logical high during time period 1124A when first signal 1102A transitions from the logical low to the logical high and when second signal 1104A transitions from the logical high to the logical low or remains at the logical low. In some implementations, at a logical high, fourth sideband interrupt signal 1128A indicates that the link is to enter an inactive link state (e.g., wake is deasserted). In other implementations, at a logical low, fourth sideband interrupt signal 1128A indicates that the link is to enter the inactive state.

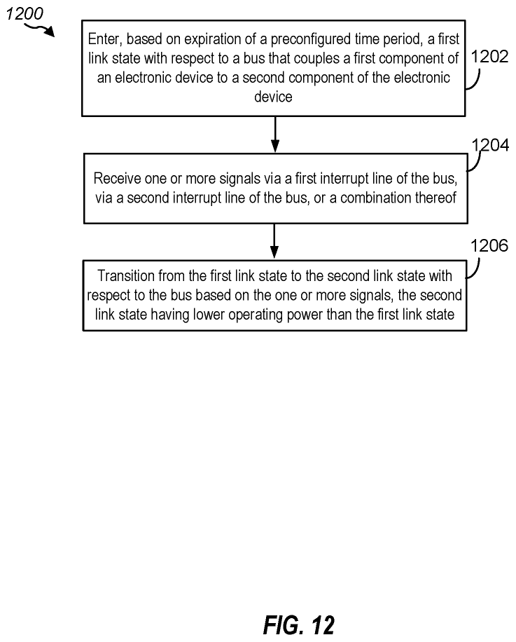

FIG. 12 is a flow a flow chart depicting an example method to facilitate a transition from a first link state to a second link state according to one or more aspects. At block 1202, a first component of an electronic device enters, based on expiration of a preconfigured time period, a first link state with respect to a bus that couples the first component to the second component of the electronic device. For example, first component 404 of electronic device 400 enters, based on expiration of a preconfigured time period, such as may be set or demarcated by clock 408, a first link state, such as an intermediary low power link state or L1 state with respect to bus 401. Bus 401 couples first component 404 to second component 410 of electronic device 400.

At block 1204, the first component receives one or more signals via a first interrupt line of the bus, via a second interrupt line of the bus, or a combination thereof. For example, first component 404 receives one or more signals via first interrupt line 414 of bus 401, via second interrupt line 416 of bus 401, or a combination thereof. As an example, the one or more signals may include a first signal and a second signal.

At block 1206, the first component transitions from the first link state to a second link state with respect to the bus based on the one or more signals. The second link state has a lower operating power than the first link state. For example, first component 404 transitions from the first link state (e.g., L1) to the second link state (e.g., L2 or L3) based on the one or more signals. The second link state (e.g., L2 or L3) has a lower operating power than the first link state (e.g., L1). First component 404 enters into a first deep power saving link state (e.g., L2) when auxiliary power is available. First component 404 enters into a second deep power saving link state (e.g., L3) when auxiliary power is unavailable.

In some implementations, to transition from the first link state to the second link state, the first component transitions from the first link state to the second link state without transitioning to a third link state having a higher operating power than the first link state and the second link state. For example, first component 420 transitions from the first link state (e.g., L1) to the second link state (e.g., L2 or L3) without transitioning to a third link state (e.g., L0) having a higher operating power than the first link state and the second link state. The third link state may correspond to an active link state, the first link state may correspond to an intermediary low power link state, and the second link state may correspond to a first deep power saving link state or to a second deep power saving link state.

In some implementations, to receive the one or more signals, the first component receives a first signal via the first interrupt line and receives a second signal via the second interrupt line. For example, first component 404 receives a first signal, such as first signal 702, via first interrupt line 414 and receives a second signal, such as second signal 704, via second interrupt line 416.

In some implementations, the first component decodes the first signal and the second signal to generate a plurality of sideband interrupt signals. The plurality of sideband interrupt signals may include a first sideband interrupt signal, a second sideband interrupt signal, a third sideband interrupt signal, and a fourth sideband interrupt signal. For example, first component 604 decodes the first signal, such as first signal 702, and the second signal, such as second signal 704, to generate a plurality of sideband interrupt signals, such as first sideband interrupt signal 622 through fourth sideband interrupt signal 628. The plurality of sideband interrupt signals may include first sideband interrupt signal 622, a second sideband interrupt signal 624, a third sideband interrupt signal 626, and a fourth sideband interrupt signal 626.

In some implementations, the first sideband interrupt signal indicates whether the first component is to transition to a next low power link state associated with a current link state indicated by a link state array. For example, the first sideband interrupt signal may include or correspond to first sideband interrupt signal 622, 822. In some implementations, during timeframe 826, when first sideband interrupt signal 822 transitions from a logical low value to a logical high value, the transition causes first component 604 to transition to a next low power link state associated with a current link state indicated by a link state array, such as LPM array 642. For instance, if a current low power link state of first component 604 corresponds to L1 and assuming that first component 604 supports L1ss, receipt, by first component 604, of first sideband interrupt signal 822 causes first component 604 to transition from L1ss to L2 or L3, since these are the next low power link states of LPM array 642.

In some implementations, the second sideband interrupt signal indicates whether the first component is to remain in the current link state, the third sideband interrupt signal indicates whether a reference clock is requested by the first component, and the fourth sideband interrupt signal indicates whether the first component is to transition to an active link state. For example, second sideband interrupt signal 624, 924 may indicate whether the first component, such as first component 602, is to remain in the current link state. For instance, if first component 604 is in an intermediary low power link state (e.g. L1), if first component 604 receives second sideband interrupt signal 624, 924, and if second sideband interrupt signal 624, 924 decodes to a logical low value, first component 604 will remain in the intermediary low power link state.

As another example, third sideband interrupt signal 626, 1026A, 1026B may indicate whether a reference clock is requested by first component 604. To illustrate, when third sideband interrupt signal 626, 1026A transitions from a logical low to a logical high, clock 608 may generate a clock signal. Conversely, when third sideband interrupt signal 626, 1026B transitions from a logical high to a logical low, clock 608 may cease generation of a clock signal.

As a further example, fourth sideband interrupt signal 628, 1128A, 1128B may indicate whether first component 404 is to transition to an active link state, such as an L0 state. To illustrate, during time period 1124A, when fourth sideband interrupt signal 1128A transitions from a logical high to a logical low, receipt, by first component 404, of fourth sideband interrupt signal 1128A may cause one or more links of bus 601 to transition to an active link state (L0) from a lower power link state. As another example, during time period 1124B, when fourth sideband interrupt signal 1128B transitions from a logical low to a logical high, receipt, by first component 604, of fourth sideband interrupt signal 1128B may be ignored.

In some implementations, prior to receiving the first signal and the second signal, the first component transmits a third signal to the second component via the first interrupt line. For example, first component 602 may transmit a third signal to second component 610 via first interrupt line 614.

In some implementations, prior to receiving the first signal and the second signal, the first component transmits a fourth signal to the second component via the second interrupt line. For example, first component 604 may transmit a fourth signal to second component 610 via second interrupt line 616.

In some implementations, prior to receiving the first signal and the second signal, the third signal and the fourth signal decode to a first value of the first sideband interrupt signal. For example, decoding circuitry 650 of second component 610 may decode the third signal and the fourth signal. The decoded third signal and fourth signal may decode to a first value of fifth sideband interrupt signal 630 (which corresponds to or is a similar signal to first sideband interrupt signal 622). For instance, the first value may correspond to a logical low, which is an indicator, by first component 604 to second component 610, that first component 604 is ready to transition from a first link state (e.g., L1) to a second link state (e.g., L2 or L3).

In some implementations, the first signal and the second signal decode to a second value of the first sideband interrupt signal. For example, the first signal and the second signal may decode to a logical high that corresponds to a value of first sideband interrupt signal 622. To illustrate, in response to decoding the third signal and the fourth signal to the first value of fifth sideband interrupt signal 630, indicating a request by first component 604 to initiate a link state transition, second component 610 may send first signal and second signal to first component 604. Decoding circuitry 605 of first component 604 may decode first signal and second signal, which may decode to a second value (e.g., a logical high) of first sideband interrupt signal 622. The second value of first sideband interrupt signal 622 may indicate an acknowledgment, by second component 610, that second component 608 has received the request, by first component 602, to transition to a lower power link state.

In some implementations, the first component transitions from the first link state to the second link state based on receipt of the second value of the first sideband interrupt signal in response to the first value of the first sideband interrupt signal. For example, first component 604 may transition from the first link state (e.g., L1) to the second link (e.g., L2 or L3) based on receipt of the second value (e.g., the logical high) of first sideband interrupt signal 622 in response to the first value of (e.g., the logical low) of fifth sideband interrupt signal 630, which corresponds to (i.e., is of a same signal type) as first sideband interrupt signal 622.

In some implementations, after transitioning to the second link state, the first component receives a fifth signal via the first interrupt line and receives a sixth signal via the second interrupt line. For example, after transitioning to a deep power saving link state, such as L2, first component 604 may receive a fifth signal via first interrupt line 614 and a second signal via second interrupt line 616.

In some implementations, the fifth signal and the sixth signal decode to a third value of the second sideband interrupt signal indicating to remain in the second link state. For example, decoding circuitry 606 may decode the fifth signal and the six signal to a third value of second sideband interrupt signal 624, and the third value may indicate, to first component, to remain in the deep power saving link state (e.g., L2).

In some implementations, the first component transitions from the second link state to a third link state associated with an active state of the first component. For example, first component 604 transitions from the second link state (e.g., L2, L3) to a third link state associated with an active state of the first component (e.g., L0).

In some implementations, to transition from the second link state to the third link state, the first component receives a seventh signal via the first interrupt line and receives an eighth signal via the second interrupt line. For example, to transition from the second link state (e.g., the L2 or L3 states) to the third link state (e.g., the L0 state) first component 604 receives a seventh signal via first interrupt line 614 and receives an eighth signal via second interrupt line 616.

In some implementations, to transition from the second link state to the third link state, the first component decodes the seventh signal and the eighth signal to a fourth value of the fourth sideband interrupt signal. For example, to transition from the second link state to the third link state, first component 604 decodes the seventh signal and the eighth signal to a fourth value of fourth sideband interrupt signal 628 (e.g., a WAKE signal). To illustrate, the fourth value of fourth sideband interrupt signal 628 may correspond to a logical low.

In some implementations, to transition from the first link state to the second link state, the first component receives, from the second component, one or more first training sets having a first sequence. For example, to transition from the first link state (e.g., L1) to the second link state (e.g., L2 or L3), first component 604 receives, from second component 610, one or more first training sets having a first sequence, such as TS1 ordered sets, TS2 ordered sets, or both. In some implementations, a third symbol (e.g., the LPM_ENTR symbol) of the TS1/TS2 ordered sets may include or correspond to a particular value, such as 0×2. The particular value may indicate a handshake process to effectuate the transition from L1 to L2 or L3. In some implementations, first component 604, receives, from second component 610, the one or more first training sets having the first sequence in response to second component 610 decoding fifth sideband interrupt signal 630 to a value (e.g., a logical high) indicating a request by first component 604 to transition to the second link state.

In some implementations, to transition from the first link state to the second link state, the first component transmits, to the second component, one or more second training sets having a second sequence in response to receipt of the one or more first training sets. For example, to transition from the first link state (e.g., L1) to the second link state (e.g., L2 or L3), first component 604 transmits, to second component 610, one or more second training sets having a second sequence, such as TS1 ordered sets, TS2 ordered sets, or both, in response to receipt of the one or more first training sets, such as the TS1 ordered sets, TS2 ordered sets, or both. For example, in response to receipt of eight consecutive TS1 ordered sets, eight consecutive TS2 ordered sets, or both from second component 610, first component 602 may transmit one or more TS1 ordered sets, TS2 ordered sets, or both, indicating, to second component 610 initiation of transition, by first component 604 into the lower power link state. In some implementations, a third symbol of the transmitted one or more TS1 ordered sets, TS2 ordered sets, or both (e.g., the LPM_ENTR symbol) includes a particular value indicating a handshake process for entry into the low power link state. For example, the particular value may correspond to 0×2. In some implementations, after transmitting the one or more second training sets having the second sequence to second component 610, first component 604 transitions to the second link state.

In some implementations, to transition from the first link state to the second link state, the first component transitions from the first link state to an intermediate link state in response to receipt of the one or more first training sets. For example, first component 604 may transition from the first link state (e.g., the L1 state) to an intermediate link state (e.g., the L2/L3 state) in response to receipt of the one more first training sets (e.g., the TS1/TS 2 ordered sets). In some implementations, first component 604 may transition from the first link state (e.g., the L1 state) to an intermediate link state (e.g., the L2/L3 state) without receipt of the one or more first training sets.

In some implementations, to receive the one or more first training sets, the first component receives a plurality of consecutive first training sets. For example, to receive the one or more first training sets, such as the TS1/TS2 ordered sets, first component 604 receives eight consecutive TS1/TS2 ordered sets.

In some implementations, to transmit the one or more second training sets, the first component transmits a plurality of second training sets. For example, first component 604 transmits a plurality of TS1/TS2 ordered sets, such as eight consecutive TS1/TS2 ordered sets.

In some implementations, the second link state represents an auxiliary power state. For example, the second link state may include or correspond to the L2 state. In some implementations, to transition from the intermediate link state to the second link state, the first component detects that auxiliary power is present and transitions to the second link state in response to detecting that auxiliary power is present. For example, to transition from the intermediate link state, such as the L2/L3 state, to the second link state, such as the L2 or L3 state, first component 604 detects that auxiliary power is present and transitions to the second link state, such as the L2 state, in response to detecting that auxiliary power is present.

In some implementations, the second link state represents an unpowered state. For example, the second link state may include or correspond to the L3 state. In some implementations, to transition from the intermediate link state to the second link state, the first component detects that auxiliary power is absent and transitions to the second link state in response to detecting that auxiliary power is absent. For example, to transition from the intermediate link state, such as the L2/L3 state, to the second link state, first component 604 detects that auxiliary power is absent and transitions to the second link state, such as the L3 state, in response to detecting that auxiliary power is absent.

In some implementations, a fifth value of the third sideband interrupt signal indicates that the first component supports an optimized buffer flush/fill (OBFF) mechanism. For example, a fifth value (e.g., a logical high, a logical low) of third sideband interrupt signal 626 indicates that the first component supports an optimized buffer flush/fill (OBFF) mechanism.

In some implementations, the first component is configured to generate a signal pattern based on the third sideband interrupt signal. For example, first component 604 is configured to generate a signal pattern based on third sideband interrupt signal 626. In some implementations, to generate the signal pattern, the first component alternates, over distinct time periods, between the fifth value of the third sideband interrupt signal and a sixth value of the third sideband interrupt signal. For example, to generate the signal pattern, first component 604 alternates, over distinct time periods, between the fifth value of third sideband interrupt signal 626 (e.g., a logical high, a logical low) and a sixth value of the third sideband interrupt signal (e.g., the other of the logical high or the logical low). In some implementations, the OBFF signaling is indicated by alternating between the fifth value and the sixth value.

In some implementations, the first signal comprises a data signal, the second signal comprises a clock signal. For example, first signal 702 may include or correspond to a data signal and second signal 704 may include or correspond to a clock signal. In some implementations, the first component is configured to process the data signal based on the clock signal. For example, first component 404 may process the data signal based on the clock signal such as may be generated by clock 426 of second component 410.

In some implementations, transitioning from the first link state to the second link state is based on the data signal indicating an acknowledgement from the second component. For example, the data signal may indicate an acknowledgment from second component 410, acknowledging a request from first component 404 to transition to the second link state.

In some implementations, prior to receiving the first signal and the second signal, the first component transmits a third signal via the first interrupt line, the third signal including a second data signal that indicates a request to transition to the second link state by the first component. For example, prior to receiving first signal 702, second signal 704, or both, first component 404 may transmit a third signal via first interrupt line 414. The third signal may include a second data signal that indicates a request, by first component 404, to transition to the second link state.

In some implementations, the one or more signals includes a modulated data signal. For instance, first component 404 may receive one or more signals that includes a modulated data signal, such as may be generated and transmitted, over first interrupt line 414, second interrupt line 416, or both by second component 410. In some implementations, the first component demodulates the modulated data signal. For instance, first component 404 may demodulate the modulated data signal using decoding circuitry 406. In some implementations, transitioning from the first link state to the second link state is based on the demodulated data signal indicating an acknowledgement from the second component, such as second component 410.

In some implementations, prior to receiving the modulated data signal, the first component transmits a third signal via the first interrupt line. For example, prior to receiving the modulated data signal, first component 402 transmits a third signal via first interrupt line 414. In some implementations, the third signal includes a second modulated data signal that indicates a request to transition to the second link state by the first component, such as by component 404.

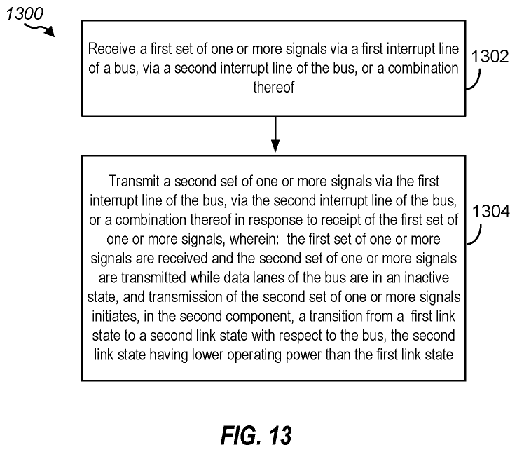

FIG. 13 is a flow a flow chart depicting an example method to facilitate a transition from a first link state to a second link state according to one or more aspects. At block 1302, a first component receives a first set of one or more signals via a first interrupt line of a bus that couples the first component to a second component, via second interrupt line of the bus, or a combination thereof. For example, second component 410 receives a first set of one or more signals via first interrupt line 414 of bus 401 that couples second component 410 to first component 404, via second interrupt line 416 of bus 410, or a combination thereof.

At block 1304, the first component transmits a second set of one or more signals via the first interrupt line of the bus, via the second interrupt line of the bus, or a combination thereof in response to receipt of the first set of one or more signals. For example, second component 419 transmits a second set of one or more signals via first interrupt line 414 of bus 401, via second interrupt line 416 of bus 401, or a combination thereof in response to receipt of the first set of one or more signals. The first set of one or more signals are received and the second set of one or more signals are transmitted while data lanes of the bus are in an inactive state. For example, the first set of one or more signals are received and the second set of one or more signals are transmitted while data lanes 418 of bus 401 are in an inactive state (e.g., in L1). Additionally, transmission of the second set of one or more signals initiates, in the second component, a transition from a first link state to a second link state with respect to the bus, the second link state having lower operating power than the first link state. For example, transmission of the second set of one or more signals initiates, in first component 404, a transition from a first link state (e.g., L1) to a second link state (e.g., L2) with respect to bus 401, the second link state having lower operating power than the first link state.

In some implementations, to receive the first one or more signals, the first component receives a first signal via the first interrupt line. For example, second component 410 may receive a first signal via first interrupt line 414. In some implementations, to receive the first set of one or more signals, the first component receives a second signal via the second interrupt line. For instance, second component 410 receives a second signal via second interrupt line 416.

In some implementations, the first component decodes the first signal and the second signal to generate a first sideband interrupt signal. For example, second component 610 decodes the first signal and the second signal to generate fifth sideband interrupt signal 630. The first sideband interrupt signal has a first value. For example, fifth sideband interrupt signal 630 may have a value corresponding to a logical low. In some implementations, in response to the first sideband interrupt signal having the first value, the first component transmits, to the second component, a third signal via the first interrupt line and a fourth signal via the second interrupt line. For example, in response to fifth sideband interrupt signal 630 having the first value (e.g., a logical low), second component 610 transmits, to first component 604, a third signal via first interrupt line 620 and a fourth signal via second interrupt line 616. In some implementations, the second component decodes the third signal and the fourth signal to generate a second sideband interrupt signal having a second value. For example, first component 604 may decode the third signal and the fourth signal to generate first sideband interrupt signal 622 having a second value, such a logical high. In response to the first sideband interrupt signal 622 having the second value, first component 604 may transition from the first link state to the second link state.

In some implementations, the first set of one or more signals comprise a first modulated data signal, the first modulated data signal indicating a request, by the second component, to enter into the second link state. For example, the first set of one or more signals comprise a first modulated data signal, the first modulated data signal indicating a request, by first component 604, to enter into the second link state.

In some implementations, the second one or more signals comprise a second modulated data signal and a clock signal, the second modulated data signal and the clock signal configured to induce, in the second component, a transition from the first link state to the second link state. For example, the second one or more signals comprise a second modulated data signal and a clock signal, the second modulated data signal and the clock signal configured to induce, in first component 604, a transition from the first link state to the second link state.

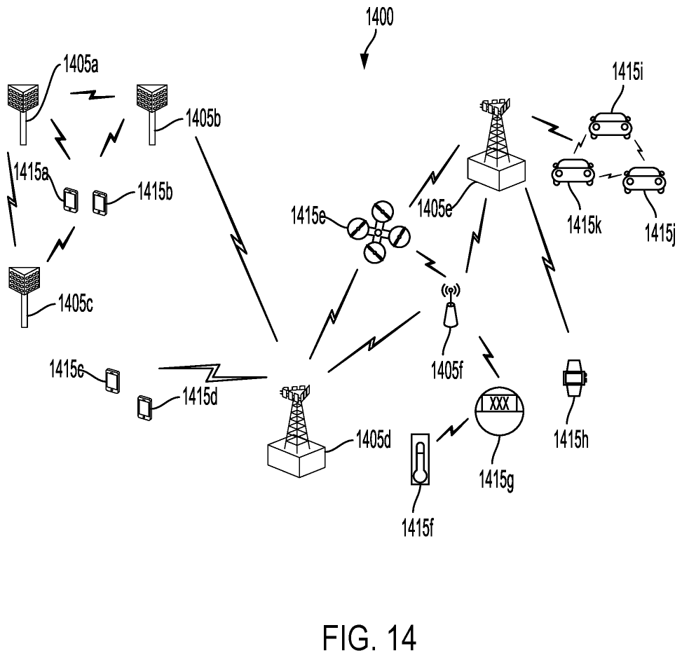

Operations of method 1200 or 1300 may be performed by a user equipment (UE), a base station (BS), other communications device, or other computer information system, such as any of the devices described with reference to FIG. 14. For example, example operations (also referred to as “blocks”) of method 1200 or 1300 may enable a UE to support greater data transfer rates at lower power consumption while communicating over high-speed communications networks. FIG. 14 is a block diagram illustrating details of an example wireless communication system according to one or more aspects. The wireless communication system may include wireless network 1400. Wireless network 1400 may, for example, include a 5G wireless network. As appreciated by those skilled in the art, components appearing in FIG. 14 are likely to have related counterparts in other network arrangements including, for example, cellular-style network arrangements and non-cellular-style-network arrangements (e.g., device to device or peer to peer or ad hoc network arrangements, etc.).

Wireless network 1400 illustrated in FIG. 14 includes a number of base stations 1405 and other network entities. A base station may be a station that communicates with the UEs and may also be referred to as an evolved node B (eNB), a next generation eNB (gNB), an access point, and the like. Each base station 1405 may provide communication coverage for a particular geographic area. In 3GPP, the term “cell” may refer to this particular geographic coverage area of a base station or a base station subsystem serving the coverage area, depending on the context in which the term is used. In implementations of wireless network 1400 herein, base stations 1405 may be associated with a same operator or different operators (e.g., wireless network 1400 may include a plurality of operator wireless networks). Additionally, in implementations of wireless network 1400 herein, base station 1405 may provide wireless communications using one or more of the same frequencies (e.g., one or more frequency bands in licensed spectrum, unlicensed spectrum, or a combination thereof) as a neighboring cell. In some examples, an individual base station 1405 or UE 1415 may be operated by more than one network operating entity. In some other examples, each base station 1405 and UE 1415 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 14, base stations 1405d and 1405e are regular macro base stations, while base stations 1405a-1405c are macro base stations enabled with one of 3 dimension (3D), full dimension (FD), or massive MIMO. Base stations 1405a-1405c take advantage of their higher dimension MIMO capabilities to exploit 3D beamforming in both elevation and azimuth beamforming to increase coverage and capacity. Base station 1405f is a small cell base station which may be a home node or portable access point. A base station may support one or multiple (e.g., two, three, four, and the like) cells.

Wireless network 1400 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 1415 are dispersed throughout the wireless network 1400, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 1415, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 1415a-1415d of the implementation illustrated in FIG. A are examples of mobile smart phone-type devices accessing wireless network 1400. A UE may also be a machine specifically configured for connected communication, including machine type communication (MTC), enhanced MTC (eMTC), narrowband IoT (NB-IoT) and the like. UEs 1415e-1415k illustrated in FIG. 14 are examples of various machines configured for communication that access wireless network 1400.

A mobile apparatus, such as UEs 1415, may be able to communicate with any type of the base stations, whether macro base stations, pico base stations, femto base stations, relays, and the like. In FIG. 14, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 1400 may occur using wired or wireless communication links.

In operation at wireless network 1400, base stations 1405a-1405c serve UEs 1415a and 1415b using 3D beamforming and coordinated spatial techniques, such as coordinated multipoint (CoMP) or multi-connectivity. Macro base station 1405d performs backhaul communications with base stations 1405a-1405c, as well as small cell, base station 1405f. Macro base station 1405d also transmits multicast services which are subscribed to and received by UEs 1415c and 1415d. Such multicast services may include mobile television or stream video, or may include other services for providing community information, such as weather emergencies or alerts, such as Amber alerts or gray alerts.

Wireless network 1400 of implementations supports mission critical communications with ultra-reliable and redundant links for mission critical devices, such UE 1415e, which is a flying device. Redundant communication links with UE 1415e include from macro base stations 1405d and 1405e, as well as small cell base station 1405f. Other machine type devices, such as UE 1415f (thermometer), UE 1415g (smart meter), and UE 1415h (wearable device) may communicate through wireless network 1400 either directly with base stations, such as small cell base station 1405f, and macro base station 1405e, or in multi-hop configurations by communicating with another user device which relays its information to the network, such as UE 1415f communicating temperature measurement information to the smart meter, UE 1415g, which is then reported to the network through small cell base station 1405f. Wireless network 1400 may also provide additional network efficiency through dynamic, low-latency TDD communications or low-latency FDD communications, such as in a vehicle-to-vehicle (V2V) mesh network between UEs 1415i-1415k communicating with macro base station 1405e.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANs.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In one or more aspects, techniques for supporting data storage and/or data transmission, may include additional aspects, such as any single aspect or any combination of aspects described below or in connection with one or more other processes or devices described elsewhere herein. In a first aspect, an electronic device, such as a UE, may be an apparatus such as a host device that includes a memory controller configured to couple to an interface to a memory system, in which the memory system may be integrated with the host device or externally coupled to the host device. The memory system may include a memory controller coupled to a memory module through a first channel and configured to access data stored in the memory module through the first channel and coupled to a host device through a first interface and configured to communicate with the host device over the first interface. The operations may be executed as part of an initialization operation, a read operation or a write operation. For instance, the memory controller of the memory system or, alternatively, a first component of an electronic device, may be configured to perform operations that include entering, based on expiration of a preconfigured time period, a first link state with respect to a bus that couples the first component to a second component of the electronic device. Additionally, the operations include receiving one or more signals via a first interrupt line of the bus, via a second interrupt line of the bus, or a combination thereof. Further, the operations include transitioning from the first link state to a second link state with respect to the bus based on the one or more signals, the second link state having lower operating power than the first link state.

In a second aspect, transitioning from the first link state to the second link state includes transitioning from the first link state to the second link state without transitioning to a third link state having a higher operating power than the first link state and the second link state.

In a third aspect, in combination with one or more of the first aspect through the second aspect, receiving the one or more signals includes receiving a first signal via the first interrupt line.

In a fourth aspect, in combination with one or more of the first aspect through the third aspect, receiving the one or more signals includes receiving a second signal via the second interrupt line.

In a fifth aspect, in combination with one or more of the first aspect through the fourth aspect, the operations further include decoding the first signal and the second signal to generate a plurality of sideband interrupt signals.

In a sixth aspect, in combination with one or more of the first aspect through the fifth aspect, the plurality of sideband interrupt signals includes a first sideband interrupt signal, a second sideband interrupt signal, a third sideband interrupt signal, and a fourth sideband interrupt signal.

In a seventh aspect, in combination with one or more of the first aspect through the sixth aspect, the first sideband interrupt signal indicates whether the first component is to transition to a next low power link state associated with a current link state indicated by a link state array.

In an eighth aspect, in combination with one or more of the first aspect through the seventh aspect, the second sideband interrupt signal indicates whether the first component is to remain in the current link state.

In a ninth aspect, in combination with one or more of the first aspect through the eighth aspect, the third sideband interrupt signal indicates whether a reference clock is requested by the first component.

In a tenth aspect, in combination with one or more of the first aspect through the ninth aspect, the fourth sideband interrupt signal indicates whether the first component is to transition to an active link state.

In an eleventh aspect, in combination with one or more of the first aspect through the tenth aspect, the operations include, prior to receiving the first signal and the second signal transmitting a third signal to the second component via the first interrupt line.

In a twelfth aspect, in combination with one or more of the first aspect through the eleventh aspect, the operations include, prior to receiving the first signal and the second signal, transmitting a fourth signal to the second component via the second interrupt line.

In a thirteenth aspect, in combination with one or more of the first aspect through the twelfth aspect, the third signal and the fourth signal decode to a first value of the first sideband interrupt signal.

In a fourteenth aspect, in combination with one or more of the first aspect through the thirteenth aspect, the first signal and the second signal decode to a second value of the first sideband interrupt signal.

In a fifteenth aspect, in combination with one or more of the first aspect through the fourteenth aspect, transitioning from the first link state to the second link state is based on receipt of the second value of the first sideband interrupt signal in response to the first value of the first sideband interrupt signal.

In a sixteenth aspect, in combination with one or more of the first aspect through the fifteenth aspect, transitioning from the first link state to the second link state includes receiving, from the second component, one or more first training sets having a first sequence.

In a seventeenth aspect, in combination with one or more of the first aspect through the sixteenth aspect, transitioning from the first link state to the second link state includes transmitting, to the second component, one or more second training sets having a second sequence in response to receipt of the one or more first training sets.

In an eighteenth aspect, in combination with one or more of the first aspect through the seventeenth aspect, transitioning from the first link state to the second link state includes transitioning from the first link state to an intermediate link state in response to receipt of the one or more first training sets.

In a nineteenth aspect, in combination with one or more of the first aspect through the eighteenth aspect, receiving the one or more first training sets includes receiving a plurality of consecutive first training sets.

In a twentieth aspect, in combination with one or more of the first aspect through the nineteenth aspect, transmitting the one or more second training sets includes transmitting a plurality of second training sets.

In a twenty-first aspect, in combination with one or more of the first aspect through the twentieth aspect, the first signal comprises a data signal.

In a twenty-second aspect, in combination with one or more of the first aspect through the twenty-first aspect, the second signal comprises a clock signal.

In a twenty-third aspect, in combination with one or more of the first aspect through the twenty-second aspect, the operations further comprise processing the data signal based on the clock signal.

In a twenty-fourth aspect, in combination with one or more of the first aspect through the twenty-third aspect, transitioning from the first link state to the second link state is based on the data signal indicating an acknowledgement from the second component.

In a twenty-fifth aspect, in combination with one or more of the first aspect through the twenty-fourth aspect, the operations further comprise, prior to receiving the first signal and the second signal, transmitting a third signal via the first interrupt line.

In a twenty-sixth aspect, in combination with one or more of the first aspect through the twenty-fifth aspect, the third signal comprises a second data signal that indicates a request to transition to the second link state by the first component.

In a twenty-seventh aspect, in combination with one or more of the first aspect through the twenty-sixth aspect, the operations further comprise transmitting a fourth signal via the second interrupt line.

In a twenty-eighth aspect, in combination with one or more of the first aspect through the twenty-ninth aspect, the fourth signal comprises a second clock signal associated with the second data signal.

In one or more aspects, such as in a twenty-ninth aspect, techniques for supporting data storage and/or data transmission, may include additional aspects, such as any single aspect or any combination of aspects described below or in connection with one or more other processes or devices described elsewhere herein. In the twenty-ninth aspect, an electronic device, such as a UE, may be an apparatus such as a host device that includes a memory controller configured to couple to an interface to a memory system, in which the memory system may be integrated with the host device or externally coupled to the host device. The memory system may include a memory controller coupled to a memory module through a first channel and configured to access data stored in the memory module through the first channel and coupled to a host device through a first interface and configured to communicate with the host device over the first interface. The operations may be executed as part of an initialization operation, a read operation or a write operation. In particular, the host device, such as a memory controller of the host device configured to couple the host device to a memory system, may execute operations that include receiving a first set of one or more signals via a first interrupt line of a bus, via a second interrupt line of the bus, or a combination thereof. Additionally, the operations include transmitting a second set of one or more signals via the first interrupt line of the bus, via the second interrupt line of the bus, or a combination thereof in response to receipt of the first set of one or more signals. The first set of one or more signals are received and the second set of one or more signals are transmitted while data lanes of the bus are in an inactive state. Further, transmission of the second set of one or more signals initiates, in a second component, a transition from a first link state to a second link state with respect to the bus, the second link state having lower operating power than the first link state.

In a thirtieth aspect, in combination with the twenty-ninth aspect, receiving the first set of one or more signals includes receiving a first signal via the first interrupt line.

In a thirty-first aspect, in combination with one or more of the twenty-ninth aspect through the thirty-first aspect, receiving the first set of one or more signals includes receiving a second signal via the second interrupt line.

In a thirty-second aspect, in combination with one or more of the thirtieth aspect through the thirty-first aspect, the operations further comprise decoding the first signal and the second signal to generate a first sideband interrupt signal.

In a thirty-third aspect, in combination with one or more of the twenty-ninth aspect through the thirty-second aspect, the first sideband interrupt signal has a first value.

In a thirty-fourth aspect, in combination with one or more of the twenty-ninth aspect through the thirty-third aspect, in response to the first sideband interrupt signal having the first value, the operations further comprise transmitting, to the second component, a third signal via the first interrupt line and a fourth signal via the second interrupt line.

In a thirty-fifth aspect, in combination with one or more of the twenty-ninth aspect through the thirty-fourth aspect, the first set of one or more signals comprise a first modulated data signal, the first modulated data signal indicating a request, by the second component, to enter into the second link state.

In a thirty-sixth aspect, in combination with one or more of the twenty-ninth aspect through the thirty-fifth aspect, the second set of one or more signals comprise a second modulated data signal and a clock signal, the second modulated data signal and the clock signal configured to induce, in the second component, a transition from the first link state to the second link state.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 2-3 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 12 or 13 may be combined with one or more blocks (or operations) described with reference to another of the figures. For example, one or more blocks (or operations) of FIG. 12 may be combined with one or more blocks (or operations) of FIG. 13.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

As used herein, the term “coupled to” in the various tenses of the verb “couple” may mean that element A is directly connected to element B or that other elements may be connected between elements A and B (i.e., that element A is indirectly connected with element B), to operate certain intended functions. In the case of electrical components, the term “coupled to” may also be used herein to mean that a wire, trace, or other electrically conductive material is used to electrically connect elements A and B (and any components electrically connected therebetween). In some examples, the term “coupled to” mean a transfer of electrical energy between elements A and B, to operate certain intended functions.

In some examples, the term “electrically connected” mean having an electric current or configurable to having an electric current flowing between the elements A and B. For example, the elements A and B may be connected via resistors, transistors, or an inductor, in addition to a wire, trace, or other electrically conductive material and components. Furthermore, for radio frequency functions, the elements A and B may be “electrically connected” via a capacitor.

The terms “first,” “second,” “third,” etc. are employed for ease of reference and may not carry substantive meanings. Likewise, names for components/modules may be adopted for ease of reference and might not limit the components/modules.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method performed by a first component of an electronic device, the method comprising:
entering, based on expiration of a preconfigured time period, a first link state with respect to a bus that couples the first component to a second component of the electronic device;
receiving one or more signals via a first interrupt line of the bus, via a second interrupt line of the bus, or a combination thereof; and
transitioning from the first link state to a second link state with respect to the bus based on the one or more signals, the second link state having lower operating power than the first link state.

2. The method of claim 1, wherein transitioning from the first link state to the second link state includes transitioning from the first link state to the second link state without transitioning to a third link state having a higher operating power than the first link state and the second link state.

3. The method of claim 1, wherein receiving the one or more signals includes:
receiving a first signal via the first interrupt line; and
receiving a second signal via the second interrupt line.

4. The method of claim 3, further comprising:
decoding the first signal and the second signal to generate a plurality of sideband interrupt signals, the plurality of sideband interrupt signals including a first sideband interrupt signal, a second sideband interrupt signal, a third sideband interrupt signal, and a fourth sideband interrupt signal.

5. The method of claim 4, wherein the first sideband interrupt signal indicates whether the first component is to transition to a next low power link state associated with a current link state indicated by a link state array.

6. The method of claim 5, wherein:
the second sideband interrupt signal indicates whether the first component is to remain in the current link state,
the third sideband interrupt signal indicates whether a reference clock is requested by the first component, and
the fourth sideband interrupt signal indicates whether the first component is to transition to an active link state.

7. The method of claim 4, further comprising, prior to receiving the first signal and the second signal:
transmitting a third signal to the second component via the first interrupt line; and
transmitting a fourth signal to the second component via the second interrupt line, wherein:
the third signal and the fourth signal decode to a first value of the first sideband interrupt signal,
the first signal and the second signal decode to a second value of the first sideband interrupt signal, and
transitioning from the first link state to the second link state is based on receipt of the second value of the first sideband interrupt signal in response to the first value of the first sideband interrupt signal.

8. The method of claim 1, wherein transitioning from the first link state to the second link state includes:
receiving, from the second component, one or more first training sets having a first sequence; and
transmitting, to the second component, one or more second training sets having a second sequence in response to receipt of the one or more first training sets.

9. The method of claim 8, wherein:
transitioning from the first link state to the second link state includes transitioning from the first link state to an intermediate link state in response to receipt of the one or more first training sets;
receiving the one or more first training sets includes receiving a plurality of consecutive first training sets; and
transmitting the one or more second training sets includes transmitting a plurality of second training sets.

10. The method of claim 3, wherein:
the first signal comprises a data signal,
the second signal comprises a clock signal,
the method further comprises:
processing the data signal based on the clock signal.

11. The method of claim 10, wherein transitioning from the first link state to the second link state is based on the data signal indicating an acknowledgement from the second component, the method further comprising, prior to receiving the first signal and the second signal:
transmitting a third signal via the first interrupt line, wherein the third signal comprises a second data signal that indicates a request to transition to the second link state by the first component; and
transmitting a fourth signal via the second interrupt line, wherein the fourth signal comprises a second clock signal associated with the second data signal.

12. A device comprising:
a controller configured to:
initiate entry, based on expiration of a preconfigured time period, to a first link state with respect to a bus that couples a first component of the device to a second component of the device;
receive one or more signals via a first interrupt line of the bus, via a second interrupt line of the bus, or a combination thereof; and
initiate transition from the first link state to a second link state with respect to the bus based on the one or more signals, the second link state having lower operating power than the first link state.

13. The device of claim 12, wherein, to initiate transition from the first link state to the second link state, the controller is configured to initiate transition from the first link state to the second link state without initiation of a second transition to a third link state having a higher operating power than the first link state and the second link state.

14. The device of claim 12, wherein, to receive the one or more signals, the controller is configured to:
receive a first signal via the first interrupt line; and
receive a second signal via the second interrupt line.

15. The device of claim 14, wherein the controller is further configured to:
decode the first signal and the second signal to generate a plurality of sideband interrupt signals, the plurality of sideband interrupt signals including a first sideband interrupt signal, a second sideband interrupt signal, a third sideband interrupt signal, and a fourth sideband interrupt signal.

16. The device of claim 15, wherein the first sideband interrupt signal indicates whether the first component is to transition to a next low power link state associated with a current link state indicated by a link state array.

17. The device of claim 16, wherein:
the second sideband interrupt signal indicates whether the first component is to remain in the current link state,
the third sideband interrupt signal indicates whether a reference clock is requested by the first component, and
the fourth sideband interrupt signal indicates whether the first component is to transition to an active link state.

18. The device of claim 15, wherein, prior to receipt of the first signal and the second signal, the controller is further configured to:
initiate transmission of a third signal to the second component via the first interrupt line; and
initiate transmission of a fourth signal to the second component via the second interrupt line, wherein:
the third signal and the fourth signal decode to a first value of the first sideband interrupt signal,
the first signal and the second signal decode to a second value of the first sideband interrupt signal, and
the transition from the first link state to the second link state is based on receipt of the second value of the first sideband interrupt signal in response to the first value of the first sideband interrupt signal.

19. The device of claim 12, wherein, to initiate transition from the first link state to the second link state, the controller is configured to:
receive, from the second component, one or more first training sets having a first sequence; and
initiate transmission, to the second component, of one or more second training sets having a second sequence in response to receipt of the one or more first training sets, wherein:
to receive the one or more first training sets, the controller is configured to receive a plurality of consecutive first training sets, and
to transmit the one or more second training sets, the controller is configured to transmit a plurality of second training sets.

20. The device of claim 14, wherein:
the first signal comprises a data signal;
the second signal comprises a clock signal; and
the controller is further configured to:
process the data signal based on the clock signal.

21. The device of claim 20, wherein, to transition from the first link state to the second link state, the data signal indicates an acknowledgement from the second component, and wherein, prior to receipt of the first signal and the second signal, the controller is further configured to:
transmit a third signal via the first interrupt line, wherein the third signal comprises a second data signal that indicates a request to transition to the second link state by the first component; and
transmit a fourth signal via the second interrupt line, wherein the fourth signal comprises a second clock signal associated with the second data signal.

22. A method performed by a first component of an electronic device, the method comprising:
receiving a first set of one or more signals via a first interrupt line of a bus, via a second interrupt line of the bus, or a combination thereof; and
transmitting a second set of one or more signals via the first interrupt line of the bus, via the second interrupt line of the bus, or a combination thereof in response to receipt of the first set of one or more signals, wherein:
the first set of one or more signals are received and the second set of one or more signals are transmitted while data lanes of the bus are in an inactive state, and
transmission of the second set of one or more signals initiates, in a second component, a transition from a first link state to a second link state with respect to the bus, the second link state having lower operating power than the first link state.

23. The method of claim 22, wherein receiving the first set of one or more signals includes:
receiving a first signal via the first interrupt line; and
receiving a second signal via the second interrupt line.

24. The method of claim 23, further comprising:
decoding the first signal and the second signal to generate a first sideband interrupt signal, wherein the first sideband interrupt signal has a first value; and
in response to the first sideband interrupt signal having the first value, transmitting, to the second component, a third signal via the first interrupt line and a fourth signal via the second interrupt line.

25. The method of claim 22, wherein:
the first set of one or more signals comprise a first modulated data signal, the first modulated data signal indicating a request, by the second component, to enter into the second link state; and
the second set of one or more signals comprise a second modulated data signal and a clock signal, the second modulated data signal and the clock signal configured to induce, in the second component, a transition from the first link state to the second link state.

26. A device comprising:
a controller configured to:
receive a first set of one or more signals via a first interrupt line of a bus, via a second interrupt line of the bus, or a combination thereof; and
initiate transmission of a second set of one or more signals via the first interrupt line of the bus, via the second interrupt line of the bus, or a combination thereof in response to receipt of the first set of one or more signals, wherein:
the first set of one or more signals are received and the second set of one or more signals are transmitted while data lanes of the bus are in an inactive state, and
transmission of the second set of one or more signals initiates, in a second component, a transition from a first link state to a second link state with respect to the bus, the second link state having lower operating power than the first link state.

27. The device of claim 26, wherein, to receive the first set of one or more signals, the controller is configured to:
receive a first signal via the first interrupt line; and
receive a second signal via the second interrupt line.

28. The device of claim 27, wherein the controller is further configured to:
decode the first signal and the second signal to generate a first sideband interrupt signal, wherein first sideband interrupt signal has a first value; and
wherein, in response to the first signal and the second signal decoding to the first value, the controller is further configured to:
initiate transmission, to the second component, of a third signal via the first interrupt line and a fourth signal via the second interrupt line.

29. The device of claim 26, wherein the first set of one or more signals comprise a first modulated data signal, the first modulated data signal indicating a request, by the second component, to enter into the second link state.

30. The device of claim 26, wherein the second set of one or more signals comprise a second modulated data signal and a clock signal, the second modulated data signal and the clock signal configured to induce, in the second component, a transition from the first link state to the second link state.
